(19) United States
(12) Patent Application Publication
(10) Pub. No.: US 2015/0046352 A1
(43) Pub. Date: Feb. 12, 2015

(54) Apparatus for Detecting Stolen Automotive Components

(71) Applicant: Ronald R. Shea, Napa, CA (US)

(72) Inventors: Danny Ray Blitz, Los Angeles, CA (US); Ronald R. Shea, Napa, CA (US)

(21) Appl. No.: 13/963,580

(22) Filed: Aug. 9, 2013

(51) Int. Cl. G06Q 30/00; G06Q 50/26; G06F 17/30

(52) U.S. Cl. CPC G06Q 30/0185; G06F 17/30876; G06Q 50/26
USPC 705/318

(57) ABSTRACT

In a system for preventing automobile theft, select automotive components are embedded with digital information and devices, including a unique public key, a unique private key, a decryption/encryption module, and a network address. Upon assembly of a vehicle, the components form addressable nodes of that vehicle. Relevant digital information of all components is recorded in a proprietary, highly secure data base at the time of manufacture, and updated for vehicular repairs. Only registered agents may access the data base or submit updates to the federal network. During refueling or re-charging of a vehicle, a digital handshake compares public keys of the vehicular components to the proprietary data base, and confirms the integrity of at least some components by a public-key/private-key challenge and response. If components have been reported stolen, or other irregularities are detected in the vehicle's network of components during the hand shake process, the vehicle is disabled, and a message is automatically transmitted to one or more law enforcement agencies, identifying the vehicle and its location.

This application is a Continuation, claiming benefit of priority of U.S. patent application Ser. No. 12/780,835 filed May 14, 2010 and issues as U.S. Pat. No. ______ on ______, which claims benefit of priority of U.S. Provisional Patent Application No. 61/303,682, filed Feb. 12, 2010. U.S. patent application Ser. No. 12/780,835 and U.S. Provisional Patent Application No. 61/303,682 are incorporated by reference in their entirety herein.

### BACKGROUND OF THE INVENTION

As the world population increases, an increasing number of people are making demands on the fossil fuel resources available to this planet. Simultaneously, the reserves of these nonrenewable resources are being drawn down. The prospect of increasing world demand and decreasing reserves poses a serious threat to world stability and peace. In view of this looming crisis, industry, and nations and consumers have sought alternative fuel vehicles, including, but not limited to electric vehicles, and hydrogen powered vehicles, and hybrids that combine multiple power systems.

Electric vehicles run an electric motor. The simplicity of an electric motor, and smoothness of operation, produces substantially less wear and tear than internal combustion engines. Electricity for electric motor driven vehicles can be provided by storage batteries within the vehicle. Although there are many different kinds of batteries (lead-acid, lithium ion, etc.) battery technology can be generally described as a migration of ions in an opposite direction of electrons, catalyzing a chemical reaction, and driving the electrons through a load. During recharging, the chemical reaction is reversed. Fuel cells have some properties similar to a battery. Hydrogen atoms separate into fundamental particles, driving the protons through a proton permeable membrane and in an opposite direction as electrons. The electron flow drives electrical devices in the same manner as a battery. The end product of the fuel cell process is to re-combine the free electron, the proton, and oxygen atoms to form water. As a consequence, the technology is extremely clean, producing no hydrocarbon emissions. The only emission is water. A fuel cell differs from a battery, primarily in that the chemicals used to drive the process are not reused, but vented to the atmosphere. A fuel cell, then, can be thought of as a “ventible battery.” Hydrogen has also been used in place of hydrocarbon fuel in traditional internal combustion engines.

Ultra capacitors have been developed in the last several years, exceeding by roughly 1000 fold the capacitance of electrical capacitors in the 1970s and 80s. At the present time, however, Ultra capacitors have not been developed which are likely to power a car for great distances. However, they may be used in conjunction with other electrical power sources (such as batteries or fuel cells) to meet high current demands of an electrical motor during acceleration such as merging on a freeway. By the use of ultra capacitors, the size and weight of batteries or fuel cells need only be sufficient for maintaining a cruising speed, and not for acceleration. This enables vehicles to be manufactured with smaller and lighter fuel cells or with batteries that need not meet the demand of excessive power draw.

Regardless of the form of power, vehicle theft remains problematic throughout the world. With new advances in technology, however, advances in vehicle antitheft security are also possible.

### BRIEF DESCRIPTION OF THE SEVERAL VIEWS OF THE DRAWINGS

FIG. 1 depicts a vehicle being re-powered at a re-powering station, equivalent to current day gas-stations.

FIG. 2A depicts a cross section of an embodiment a re-powering hose used to re-power a vehicle as in FIG. 1.

FIG. 2B depicts an alternative cross section of an embodiment of a re-powering hose used to repower a vehicle as depicted in FIG. 1

FIG. 3A depicts is an embodiment of the re-powering station in FIG. 1 in communication with the Smart Grid.

FIG. 3-B depicts an alternative embodiment of the re-powering station of FIG. 1 in communication with the Smart Grid.

FIG. 4 depicts a first vehicular component of the vehicle of FIG. 1 including a first group of digital components.

FIG. 5 depicts a second vehicular components within the vehicle of FIG. 1, including a second group of digital components.

FIG. 6 depicts an embodiment of a portion of a data base (“look-up table”) and digital fields within the Smart Grid for analyzing the theft status of the vehicle of FIG. 1

FIG. 7A describes an embodiment for a process for determining whether the vehicle, or the vehicular components of FIGS. 4 and 5 have been stolen, from steps 701-713.

FIG. 7B is directed to steps 715-734 of the process initialized in FIG. 7A for determining whether a vehicle or vehicular components of FIGS. 4 and 5 have been stolen.

FIG. 7C is directed to steps 735-757 of the process initialized in FIGS. 7A and 7B for determining whether a vehicle or vehicular components of FIGS. 4 and 5 have been stolen.

FIG. 7D is directed to steps 759-775 of the process initialized in FIGS. 7A, 7B and 7C for determining whether a vehicle or vehicular components of FIGS. 4 and 5 have been stolen.

FIG. 7E is directed to steps 777-787 of the process initialized in FIGS. 7A, 7B, 7C and 7D for determining whether a vehicle or vehicular components of FIGS. 4 and 5 have been stolen.

FIG. 8 depicts an embodiment of a set of digital fields within the Smart Grid of FIGS. 3A, 3B which are used to analyze the status of the vehicle of FIG. 1 and determine if the vehicle or parts thereof have been reported stolen.

FIG. 9A depicts an embodiment of a network of a vehicular component as shown in FIGS. 4 and 5 as they might be assembled within the vehicle depicted in FIG. 1, and a user interface device by which an authorized agent can access the network of automobile components.

FIG. 9B depicts an alternative embodiment of a network of a vehicular component as shown in FIGS. 4 and 5 as they might be assembled within the vehicle depicted in FIG. 1

FIG. 10 depicts a method for controlling access to the Smart Grid while allowing mechanics to register new components depicted in FIG. 4 when they are installed in a vehicle of FIG. 1.

FIG. 11 depicts a method of utilizing an embodiment of the data tables of FIGS. 6 and 8 for inventory control and maintenance of vehicles, such as maintaining combat readiness of a fleet of military vehicles.

FIG. 12A depicts an example of a message notifying a consumer about hardware recalls and updates—both optional and required.

FIG. 12-B depicts an example of a message notifying a consumer about software recalls and updates—both optional and required.

FIG. 13 depicts a vehicle dashboard with electrical ports allowing portable digital devices (FIG. 14) to be coupled to the vehicular network.

FIG. 14 depicts a portable electronic device electrically coupled to one of the electrical ports of FIG. 13 by electrical cable (cable not shown).

FIG. 15 depicts a process for configuring the anti-theft module of the portable electronic device of FIG. 14.

FIG. 16A depicts steps 1601-1615 of a process for registering the portable electronic device of FIG. 14 with the smart grid of FIGS. 1, 3A and 3B.

FIG. 16B is directed to steps 1617-1625 of the process initialized in FIG. 16A for registering the portable electronic device of FIG. 14 with the smart grid of FIGS. 1, 3A and 3B.

FIG. 16C is directed to steps 1627-1635 of the process initialized in FIGS. 16A and 16B for registering the portable electronic device of FIG. 14 with the smart grid of FIGS. 1, 3A and 3B.

### DETAILED DESCRIPTION

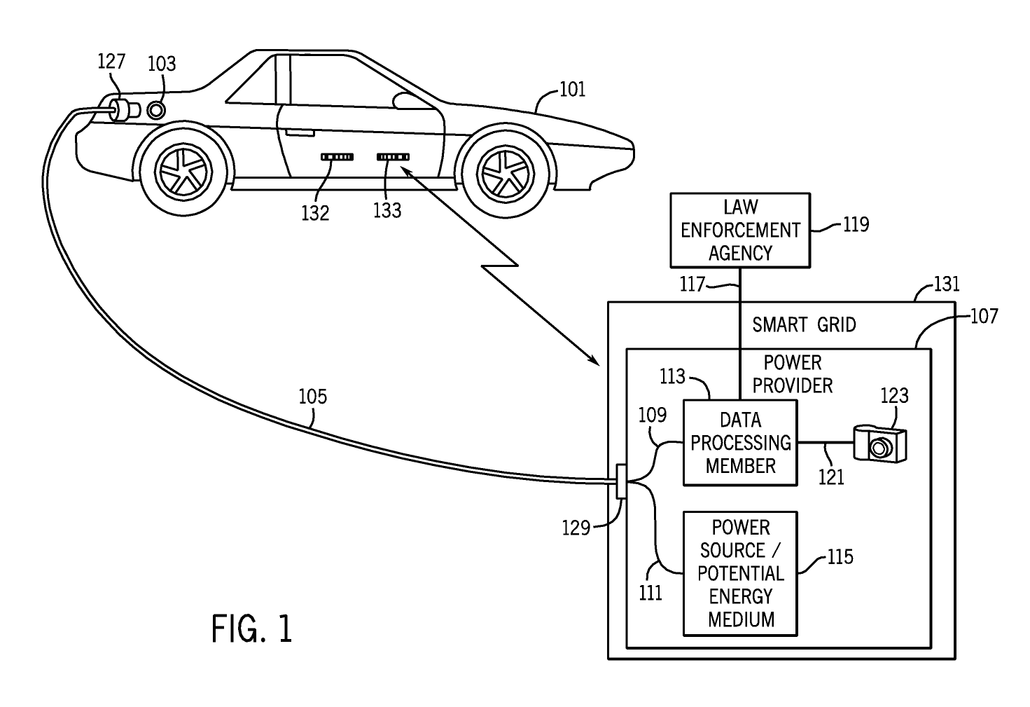

FIG. 1 depicts an embodiment in which a vehicle 101 is being re-powered by a Power Provider 107. As used herein, the term “re-powering,” comprehends the electrical recharging of battery powered vehicles, ultra capacitors or other electrical-charge carrying devices, as well as refueling a vehicle with a chemical potential energy medium 115 such as gasoline or hydrogen. In a similar manner, the term “potential energy medium” comprehends all known forms of potential energy used to re-power vehicles, including, but not limited to, electricity, hydrogen, and fossil fuels.

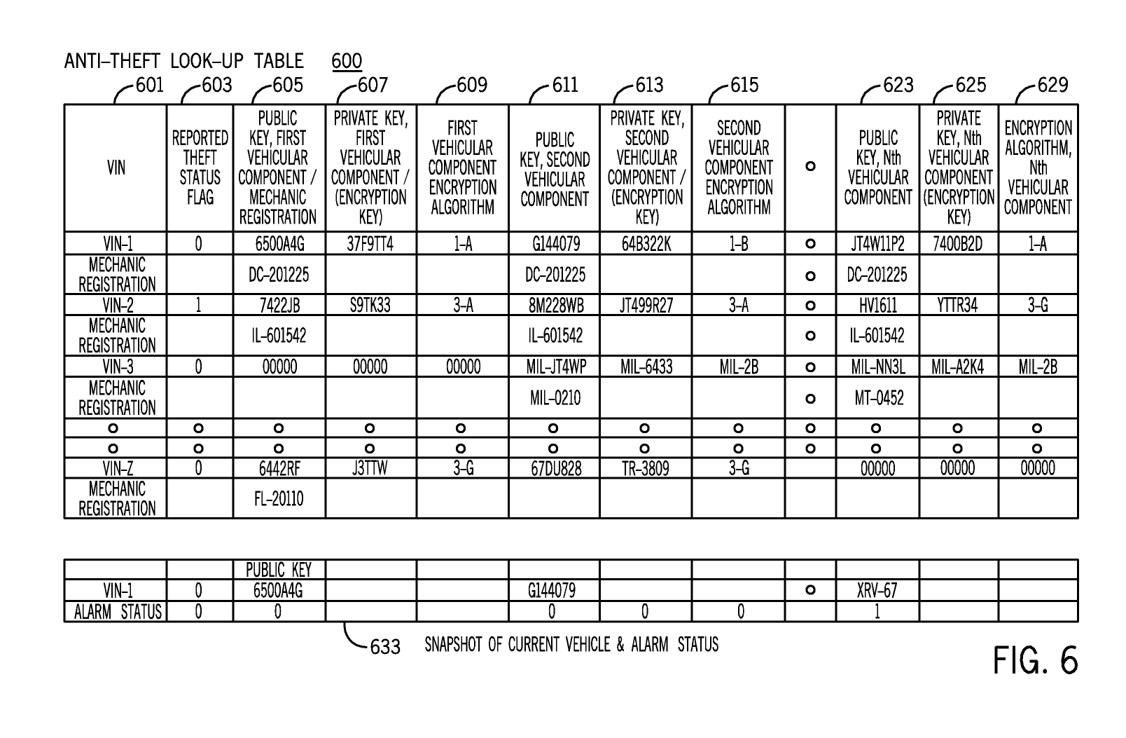

As used herein, the term “Power Provider” 107 is used to refer to the local Power Providers (e.g. a gas stations) that re-power vehicles with fossil fuel, electricity, hydrogen or other potential energy mediums. The Power Provider includes digital components 113 including, but not limited to, processors 303, memory devices and communication devices. The digital components of the Power Provider may therefore be regarded as interfacing with the Smart Grid, or as part of the Smart Grid 131, which includes local and central data bases, and the digital communication network associated therewith. The Smart Grid engages in the collection and analysis of vehicular data (including but not limited to the data depicted in lookup table 600 of FIG. 6), and the administration and control of select functions executed by a local Power Providers. Functions such as report generation to local law enforcement authorities 119 and disabling of stolen vehicles are preferably done through digital signaling. Whether these functions are initiated by the Power Provider, or are initialized at remote locations, is therefore transparent to the functionality of the system described herein Alternative embodiments of local and distributed control are envisioned.

Although the term “Smart Grid” is often associated with the electrical power transmission, throughout this disclosure, the term “Smart Grid” is used in a much broadest sense, and represents a network which monitors and controls not only the distribution of electrical power, but also of hydrogen, petroleum fuel, and other energy sources used to power vehicles and vessels.

The Power Provider 107 is coupled to the vehicle by an energy transfer line 105 which transfers a potential energy medium 115 from the output node 127 of the Power Provider to input node 103 of the vehicle.

An embodiment, the potential energy medium 115 may be a chemical medium such as hydrogen, or a hydrocarbon fuel. In such embodiments, the energy transfer line 105 includes a tubular hose. Low pressure tubular hoses are preferably used to deliver gasoline to vehicles in a re-powering process. High pressure hoses are preferably used to deliver pressurized natural gas and pressurized hydrogen refueling. In cryogenic applications using liquid hydrogen, it will readily be appreciated that the energy transfer line 105 (e.g. the hose) must include design features which allow it to remain functional and reliable at extremely low temperatures. The input node 103 of a vehicle energized by a chemical potential energy medium 115 includes a hollow tubular structure configured to mate with the output node 127 of the power source. Gasoline pumps nozzles, and the nozzle receptacles within gasoline powered vehicles are commonly known examples.

In an alternative embodiment, the potential energy medium 115 is electricity, and the energy transfer line 105 includes an electrically conductive cable or pathway with sufficient cross sectional area to deliver power as a practical rate. The output node 127 coupling the transfer line of the electrical power source to the input node 103 of the vehicle 101 may operate by a conductive electrical coupling, an inductive electrical coupling, or a combination of both.

A camera 123 is electrically coupled to the Smart Grid by signal path 121. The camera is preferably automated by robotic swivel apparatus for directional focus, automated depth of field focus, and software applications designed to identify and focus on human faces and license plates. The camera is preferably in communication with the Smart Grid through an intermediary station such as the local Power Provider 107. Embodiments are envisioned, however, wherein the camera is directly coupled to the smart grid, and is not controlled from apparatus of the local Power Provider, and does not store recorded images on the site of the local Power Provider.

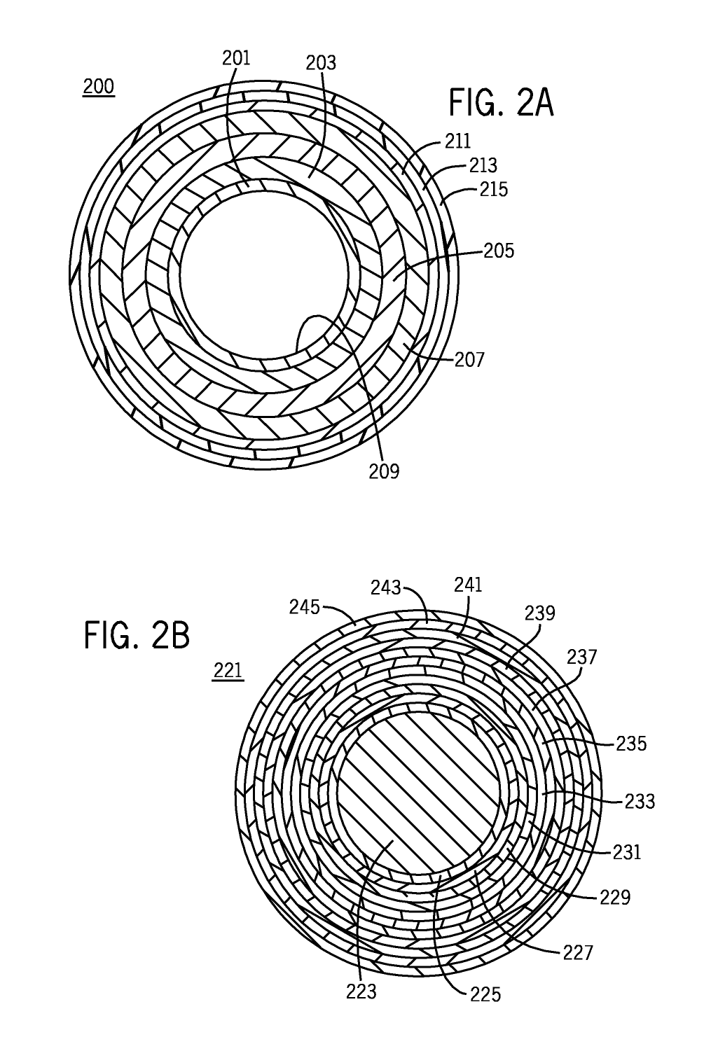

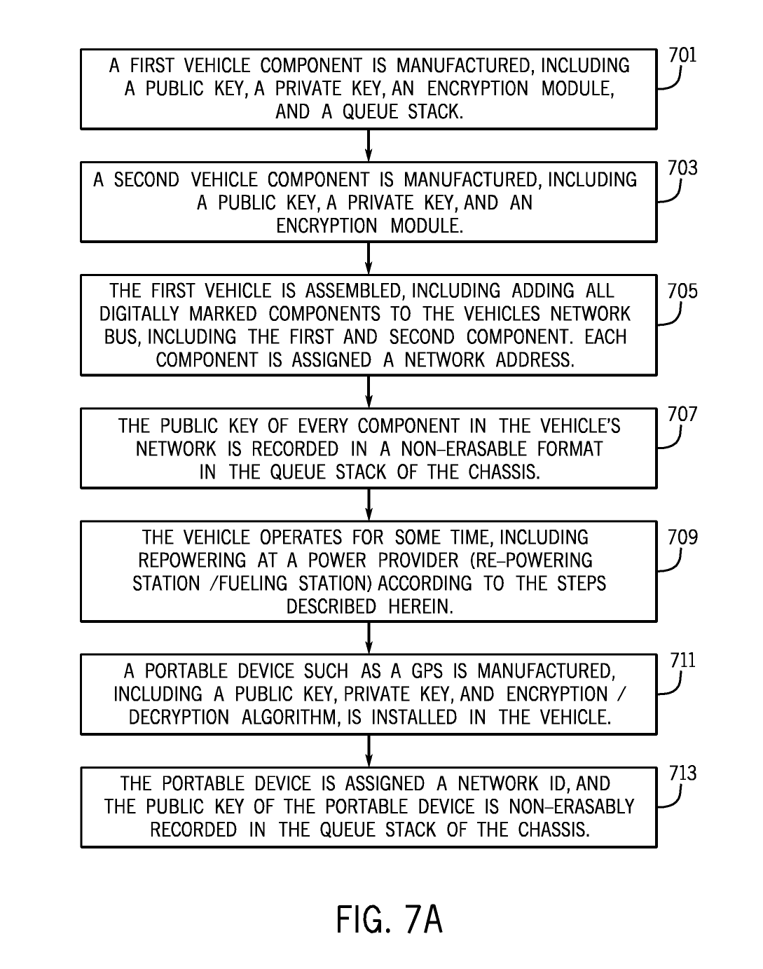

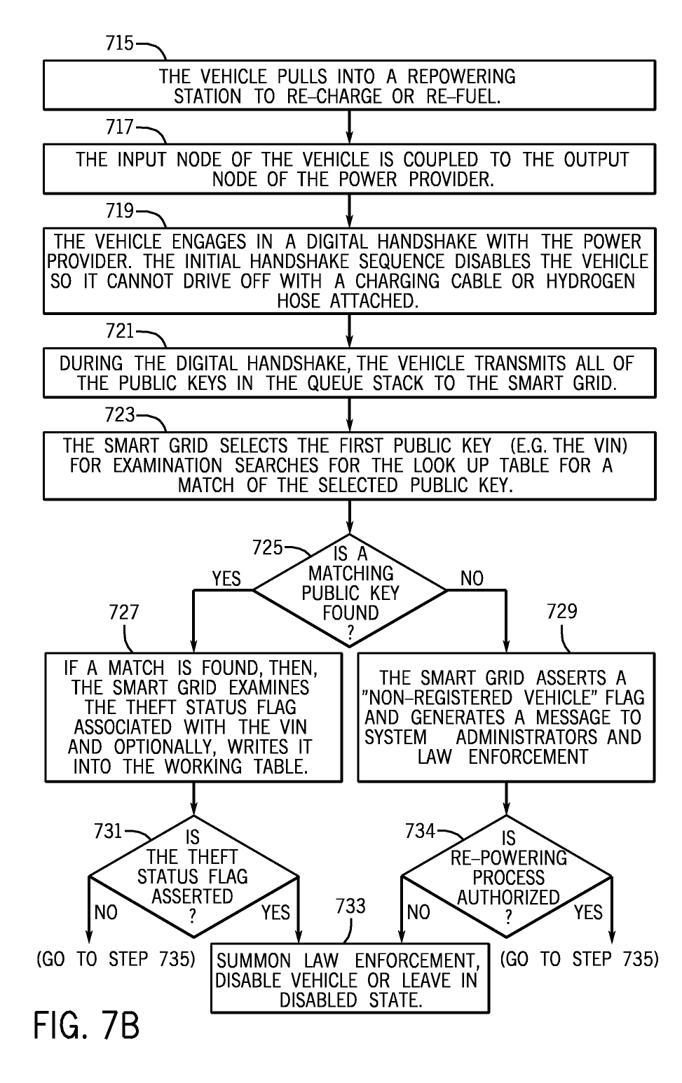

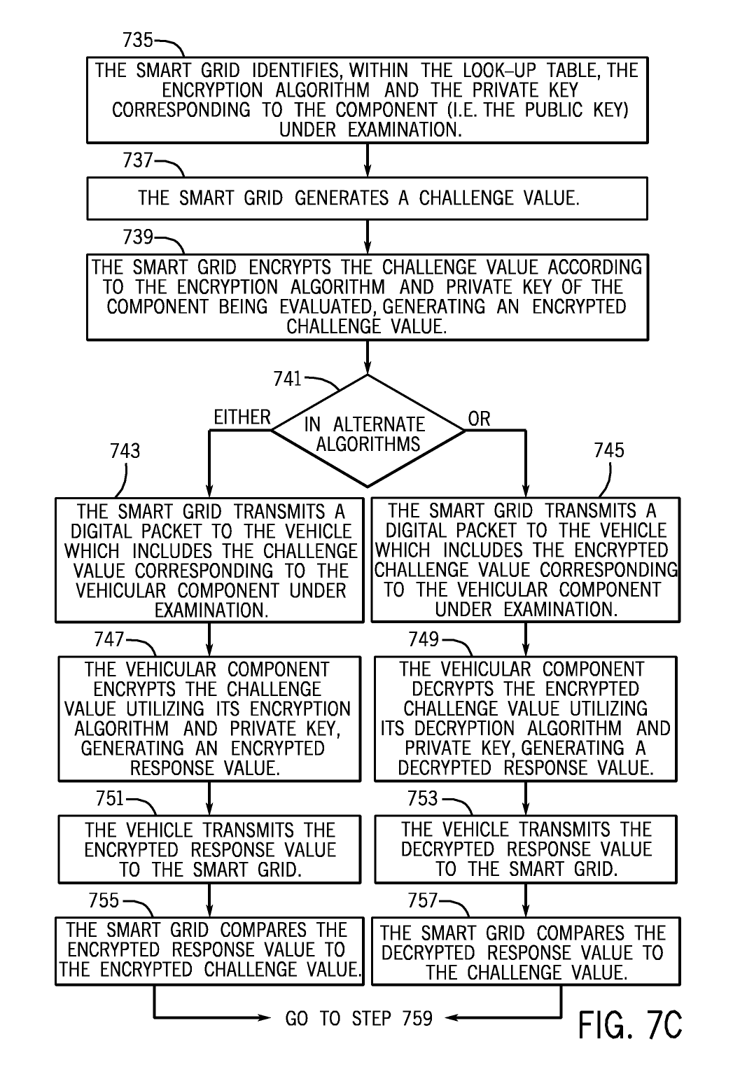

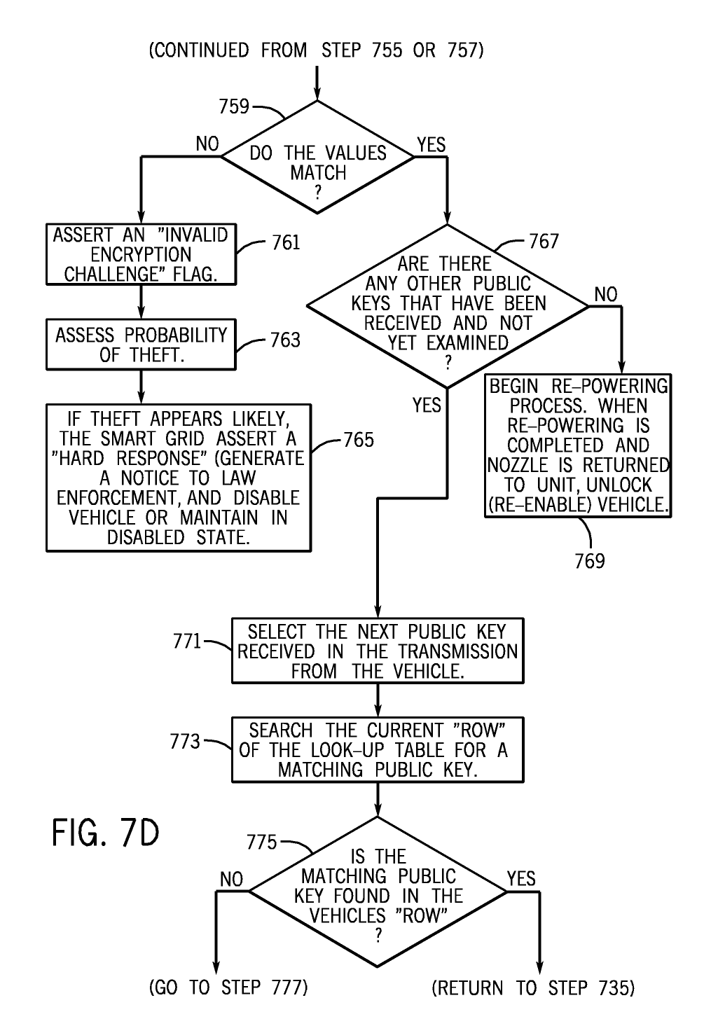

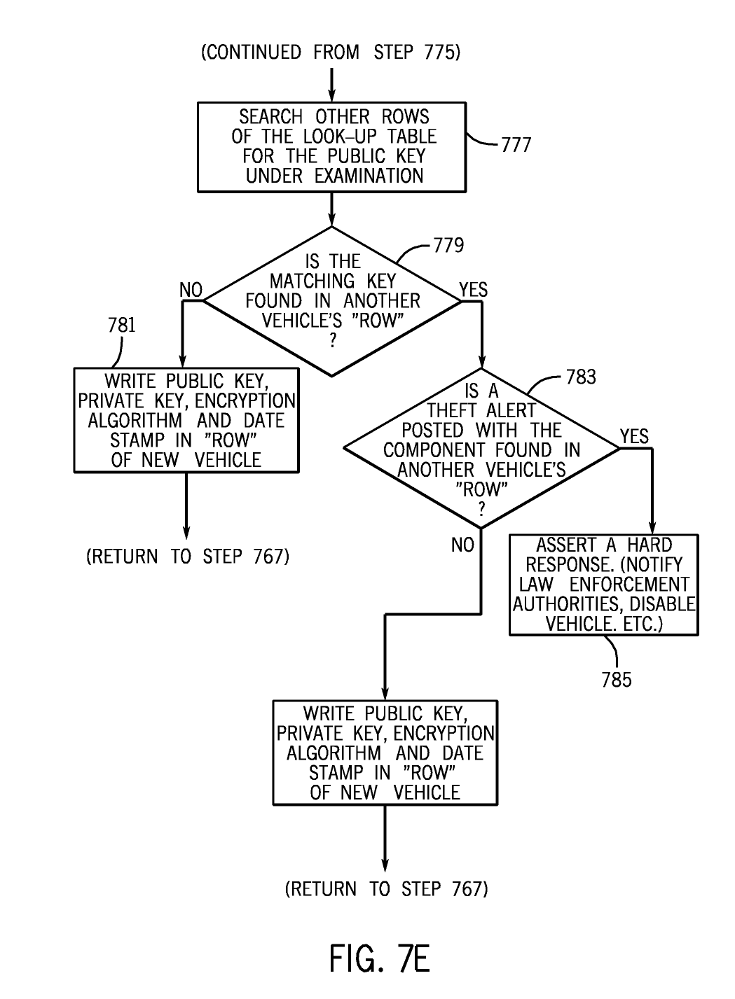

FIG. 2A depicts a cross sectional view of a hollow tub embodiment 200 of the energy transfer line 105 of FIG. 1. A hollow section 209 for transferring a chemical potential energy medium (hydrogen, gasoline, etc) is surrounded by a chemically resistant material 201 selected to resist deterioration and leakage that might be induced by the chemical potential energy medium. The resistant layer 201 is surrounded by a first electrically conductive layer 203 which is surrounded by first electrically insulating layer 205 surrounded by a second electrically conductive layer 207 surrounded by a second electrically insulating layer 211 surrounded by an electromagnetic shield layer 213 surrounded by an outer insulative layer 215. According to this configuration, the digital communication with the smart grid, and the process described in FIG. 7, may be conducted with traditional petroleum based vehicles, or hydrogen vehicles.

FIG. 2B depicts an alternative embodiment 221 of the energy transfer line 105 of FIG. 1 configured to transmit electrical power for recharging energy storage units of an electric vehicle. The core 223 is comprised of an electrically conductive material having a cross section suitable to transmit electricity at levels appropriate for recharging a vehicle in a predetermined time period. The second layer 225 is a first electrically insulating layer. The third layer 227 is an electrically conductive layer functioning as a return line for power transmission. The fourth layer 229 is a second electrically insulating layer. Although embodiments are envisioned in which digital signal transmission occurs over the power lines 223, 227, FIG. 2B depicts additional conductive and insulating layers which can accommodate digital signal transmission over lines distinct from the power transmission lines 223, 227. Layer 231 comprises an inner conductive shield to protect the digital signal transmission lines from noise induced by the power lines 223, 227. In embodiments in which power is transmitted through a coaxial cable design, however, such as depicted in FIG. 2B, an inner shield layer is optional. Layer 233 forms a third insulating layer surrounding the inner shield layer. Layer 235 functions as a first signal conductor and layer. Layer 237 functions as a fourth insulating layer surrounding the first signal conductor layer. Layer 239 functions as a second signal conductor layer. Layer 241 is a fifth insulating layer that surrounds the second signal conductor layer. Layer 243 comprises an outer shield layer, and layer 245 comprises an outer insulating layer.

In both chemical and electrical embodiments, the transfer line 105 can therefore function to exchange data between the data processing member of the power source in the vehicle. The data exchange may be in the form of analog data, digital data, or a combination of digital and analog data. Information exchanged between the vehicle and the Power Provider 107 across the transfer line 105 may be in the form of electrical signaling, optical signaling, or combinations of both. In embodiments in which the transfer line functions as a data exchange line, data may be super-positioned on the power signal used to charge the vehicle. In an alternative embodiment, such as FIG. 2B, the transfer line 223, 227 used in the transfer of a potential energy medium is electrically separate from the one or more signal channels 235, 239 used to transfer data.

RF Signal Embodiments

Referring again to FIG. 1, in an alternative embodiment, a vehicle 101 is equipped with one or more “active” RF (radiofrequency) transmitters 132, or “passive” radiofrequency (RF) tags 133. When stimulated by an electrical signal, RF tags emit a radio fingerprint much as a “bar-code” emits in the visible light spectrum. Although the term “transmission” is more generally associated with an active RF transmitter, and “emission” is more generally used with a passive RF tag, as used within this disclosure, the use of either term—“transmit” or “emit,” fully comprehends active and passive RF transmission.

During the re-powering process, the Power Provider 107 initiates a radiofrequency transmission for reading the one or more RF transmitters or RF tags. Each has a RF tag responds by transmitting a unique digital ID.

During the re-powering process, the passive RF tags are electronically scanned, and compared with the data received from the RF transceiver. By this process, the authenticity of passive RF tags can be confirmed every time a vehicle is re-powered.

An advantage of powered RF transmitters 132 is that they can more readily be utilized to transmit alternative signal patterns, and not simply a “fixed” signal pattern typically embedded in, and transmitted by, a passive RF tag. As will be appreciated in conjunction with subsequent figures, a variety of signals, including cyclical redundancy checks, encrypted “challenge and response” signals, and so forth, will advantageously be transmitted between the vehicle 101 and the smart grid 131. Since challenge and response values typically will be different every time a vehicle goes to a re-powering station, a powered RF transmitter would be more flexible in performing this function.

In a first hybrid RF embodiment, passive RF tags can be used in conjunction with a powered RF signal transmitter. During the re-powering process, digital signals subject to change, such as encrypted challenge and response signals, cyclical redundancy checks, etc. can be transmitted and received by an RF signal transmitter/receiver, or by electrical or optical connection. This transmission would include the “public key” of various components of the automobile 101 as discussed further below. Passive RF tags will also have the “public key” of a respective vehicular component. If, in the re-powering process, the public key transmitted by the passive RF tags did not match the public key(s) “actively” transmitted, and which respond to an encrypted challenge and response, the Smart Grid would determine that tampering had occurred, and that the passive RF tags were not authentic. The “challenge and response” process for detecting stolen components is discussed in greater detail below.

In yet another embodiment, passive RF tags are utilized in conjunction with a “hard wire” signal component, such as the signal transfer structure of FIGS. 2A and 2B. Encryption challenge and responses, CRCs, and other “variable” signals can be transmitted between the vehicular components and the Smart Grid over a signal bus, which may include electrical signal paths, optical signal paths, or combinations thereof. The “hard wire” component network is explained in further detail herein. In a combination of an RF and “hard wire” network, the vehicular components identify themselves over the signal bus. Passive RF tags can be “confirmed” as authentic during the re-powering process. As noted above, the passive RF tags can then be scanned at various locations by law enforcement authorities 119 to track vehicles in emergency situations.

RF tags may be read at alternative locations, and not simply refueling stations. For example, some toll roads have an “electronic pass” Lane, in which people with RF tags do not need to slow down to pay the toll. Rather, the RF tags are read while the car is moving. It will be readily appreciated, therefore, that antitheft embodiments described herein in conjunction with the re-powering process can be equally applied to moving vehicles passing under a bridge or a traffic light fitted with an RF tag reader. By this embodiment, even if a stolen vehicle or a vehicle using stolen parts were re-powering a stolen vehicle “off the grid” to avoid detection, the stolen vehicle, or parts of scavenged from a stolen vehicle could be detected through an RF transmission on the open highway without the knowledge of the driver. “Tag readers” can by positioned at any point on a highway, such as at traffic lights, underpasses, etc. Moreover, in emergency situations (such as “Megan alerts” warning of suspected child abduction, or suspected criminal flight), the location of a vehicle can be detected at intersections or underpasses before it every refuels. Passive RF tags of a vehicular components thereby allow police, or automated surveillance devices distributed along highways, to identify stolen vehicles (including stolen “chop shop components), or vehicles suspected of harboring criminals, prior to refueling or repowering.

In view of these multiple alternative embodiments, it will be appreciated that specific examples described in specific terms of transmission of a digital signal over an electrically conductive path of the transfer line 105, are offered for exclusively clarity of illustration, and are not intended to limit the spirit and scope of the appended claims, which comprehend alternative embodiments, including, but not limited to alternative embodiments described herein.

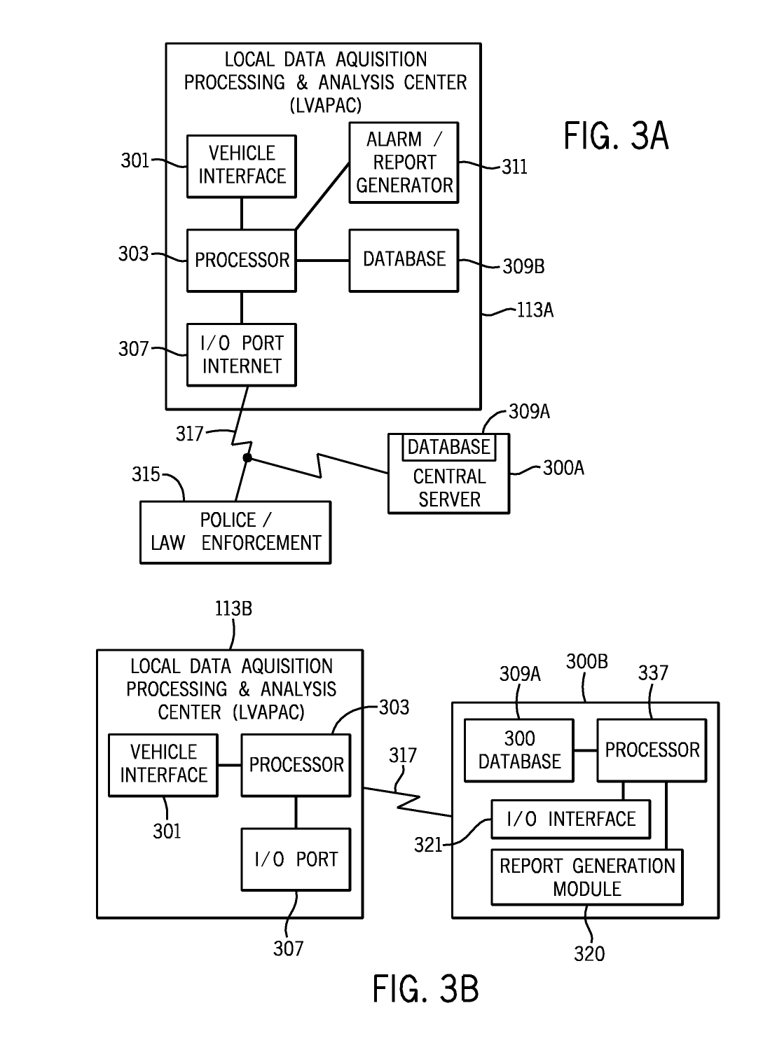

Referring to FIGS. 1 and 3 upon receiving a digital signal from the vehicle 101, the Smart Grid 131 analyzes vehicular data to determine, inter alia, if the vehicle or individual components of the vehicle have been reported as stolen, or otherwise appear to be stolen. As discussed in further detail in FIG. 3, this functionality of the Smart Grid may be distributed one or more locations, including local Power Providers.

FIG. 3-A depicts a first architecture of a Smart Grid having select architectural features and functionality within the “local” Power Provider 107 of FIG. 1. The local data acquisition, processing and analysis Center (LDAPAC) 113-A includes, in functional arrangement, a vehicle interface 301, a processor 303, an alarm/report generator 311, an I/O port interface 307 (such as an Internet portal) and a local (mirror) database 309-B. Because digital architecture is commonly known to those skilled in the art, the architecture depicted in FIG. 3A is offered to conceptually communicate the general functionality of the LDAPAC, and is not offered as a comprehensive representation of specific architectural details, nor is it intended to limit the architecture of an LDAPAC. The LDAPAC 113-1 within the local Power Provider includes the mirror database 309-B containing all the necessary data and functionality to analyze vehicular data and determine if a vehicle is stolen. In an embodiment, the LDAPAC 113-A has the capacity to generate reports and initialize transmission to law-enforcement agencies 315. It will be readily appreciated, however, that the report and alarm generation capabilities can alternatively reside in the central server 300-A, or may be distributed anywhere else within the network.

Additionally, it is appreciated that a “re-powering station” may, for an electric car, simply be plugging into an outlet in the base of a “power box” at the side of the road on an interstate expressway, or hooking up to a repowering cable in one's garage at night.

In an embodiment, the minor database 309-B will also contain data for identifying individual vehicles in order to allocate power to individual vehicles commensurate with the capacity of the power grid. This functionality enables a “smart grid” to “queue” vehicles in the charging process, thereby preventing grid overload. For example, following “rush hour,” an overload of vehicles may be expected to plug into the grid. Certain vehicles are given priority for immediate recharging, and others have their recharging deferred to a later time. One means of determining priority could be the agreement by a consumer to pay a higher fee for earlier recharging. Immediate recharging might be 14 cents per KWH, and deferred recharging performed in the middle of the night could be, for example, 6 cents per KWH. A consumer could enter a “default” program for recharging, which is recorded within the vehicle, and communicated automatically with the grid. For example, the “default” program in a vehicle could require that, if there is less than one-quarter charge, the vehicle is to receive a partial charge during peak demand (up to one-quarter of the battery's capacity) with the remainder of the charging to be performed during low demand in the middle of the night. If a consumer anticipates that they will need more than a quarter charge shortly after plugging in to the grid, the consumer can enter programming instructions to override the default recharging program, instructing that the vehicle commence full charging during the “peak” hours (immediately following AM and PM rush hours). Because “peak” electricity costs can vary from day to day, depending on demand, in an embodiment, a consumer may program a vehicle to request confirmation prior to recharging during peak hours. Prior to recharging, vehicles configured to commence charging during peak hours are advised of the “instant” electricity rate, and consumer is advised of the “instant” electricity rate. This information will advantageously be displayed on a display screen in the vehicle, or at the charging unit.

Financial information such as credit card numbers are also advantageously stored in a data base in the smart grid, or stored in a digital storage area within the vehicle, and communicated to the smart grid when recharging at “public” charging units. In the recharging process, the consumer couples his or her vehicle 101 (FIG. 1) to a public charging unit, and the financial transaction is approved in the hand shake between the vehicle and the smart grid. If credit card or other account information is digitally stored in the vehicle, it is communicated to the smart grid during the digital hand shake. If financial information is stored in a data base in the smart grid, the hand shake simply authorized payment, and confirms the identity of the vehicle, and of the financial account. Confirmation of account information may be encrypted to reduce the opportunity for identity theft. Alternatively, if the account information is stored in a data base in the smart grid, the authorization during the digital hand shake will not require the transmission of financial information. In such embodiments, a CRC or encryption/decryption challenge and response will be sufficient to authorize a financial transaction in payment for power.

A vehicle will also have the capacity to return power to the grid during peak demand times. Because power is more expensive during peak demand times, a vehicle will be able to supply power to the grid at a higher price during peak demand, and recharge at a lower price during a time of low power demand. The terms authorizing the implementation of this a reverse powering process may be programmed into the vehicle by the owner. For example, a consumer may limit authorization to times when the “difference” will favor the consumer a minimum of six cents per kilowatt hour. The program would therefore have to inquire from the smart grid the costs of electricity at the peak demand that day, and also at the low demand times during that day. The rate difference on any given day could be contractually agreed in the hand shake between the smart grid and the vehicle. Because most batteries have a limited number of recharging cycles, the reader will appreciate that each reverse powering process degrades the life of a battery, and therefore, has a calculable cost. According to a preferred embodiment, a software applications will calculate whether such a power-lending cycle carries with it an economic profit or loss.

The Smart Grid is also programmed to collect and analyze vehicular data, “tune” or “optimize” vehicular performance, or generate statistical reports to manufacturers of vehicular components regarding recalls, updates, or other messages related to vehicular performance and safety.

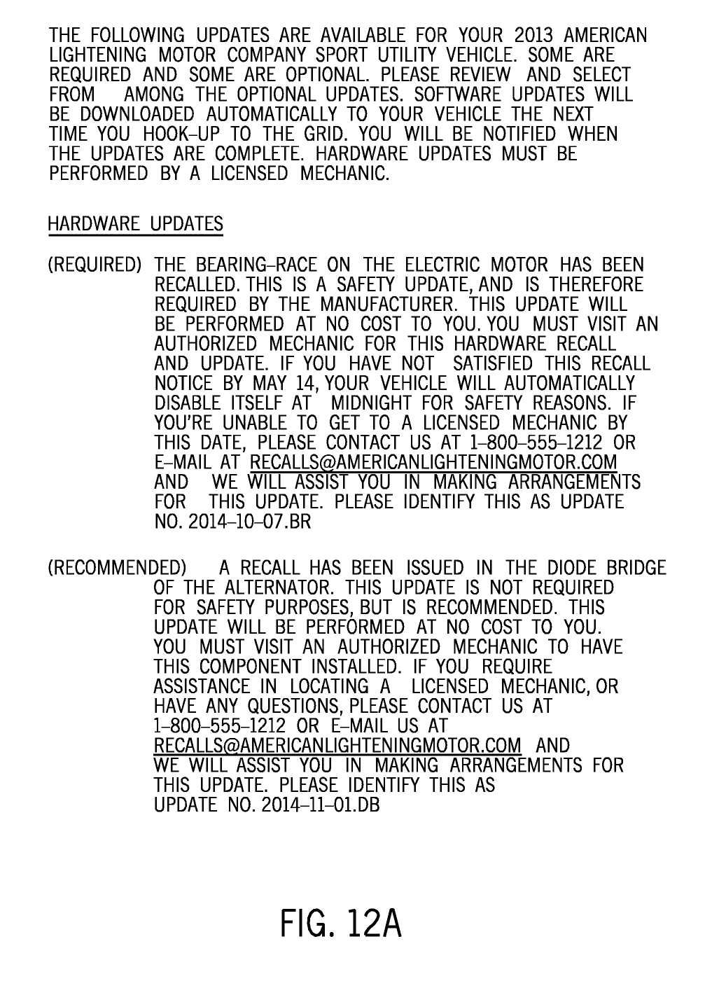

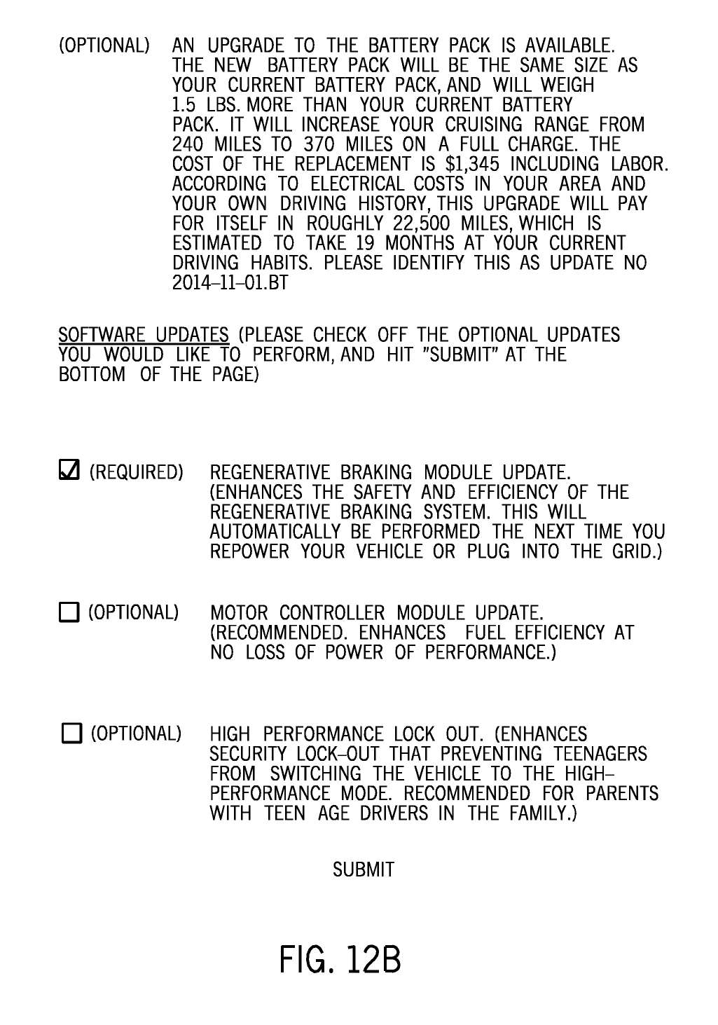

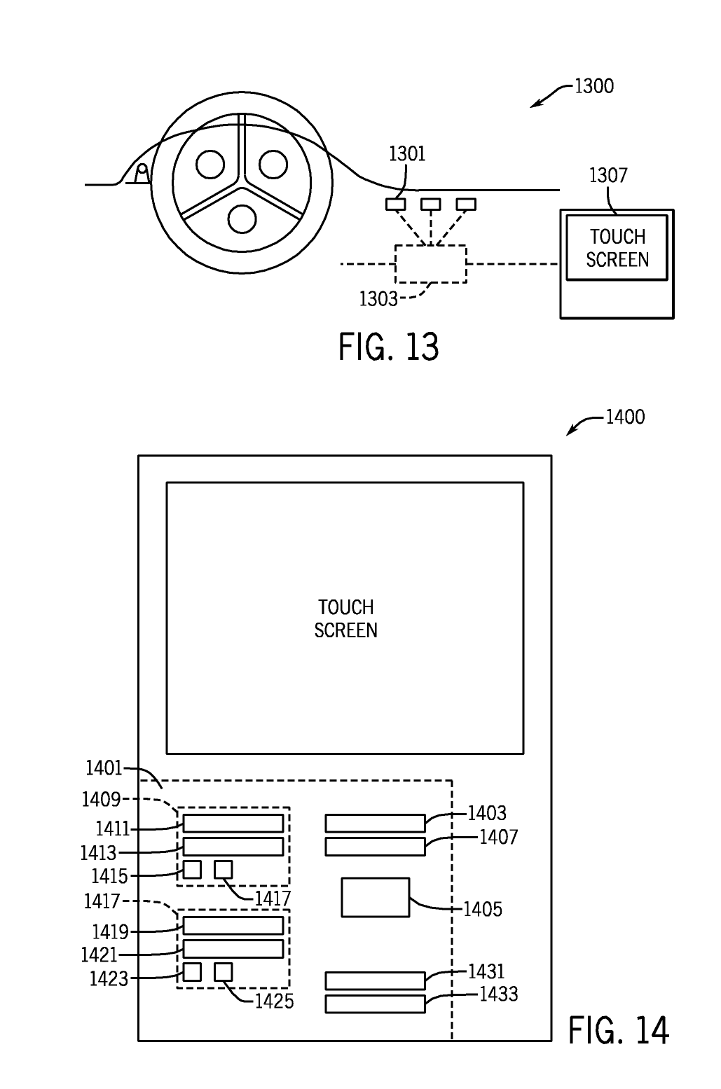

As digital programs are improved and optimized, embodiments are envisioned wherein software or “firmware” updates are downloaded into vehicles during the re-powering process. Updates and recalls can be targeted to specific vehicles, and communicated to the owner or driver via e-mail or Internet. Alternatively, on in addition to these notices, updates and recalls may be displayed on a monitor within the vehicle, or at the re-powering station. Hardware updates and “recalls” may be communicated in a similar manner. FIGS. 12 and 13 illustrates some of the types of messages and message formats that can be communicated through the Smart Grid. Recall notices and upgrades can distinguish whether a recall upgrade is required or optional, whether it is free of cost or will cost the consumer money, the nature of the upgrade, contact information for the vehicle manufacturer, and, in the case of hardware updates or recalls, the location of licensed mechanics.

Returning to FIG. 3-A, the Smart Grid includes a central server 300-A in communication with the LDAPAC 113-A which, according to the embodiment of FIG. 1, is located at the Power Provider. The central server includes a central database 309-A which is used to update the local database 309-B of the local LDAPAC 113-A. To protect the central database 300A from “hacking,” the central database is ultra-secure, and communication between the smart grid and the vehicles is performed exclusively through minor data bases 309 B. As the minor databases are updated through communication with actual vehicles, the minor data bases provide updates to the central database in an ultra-secure manner. As new components are manufactured, the digital information relating to these components (e.g. public key, private key, encryption algorithm, etc.) is downloaded into the central data base, from which updates are sent to the mirror data bases.

The databases 309A, 309B will advantageously include part numbers of vehicular components in association with their respective vehicles, and a theft status of vehicles and vehicular components, identifying whether the vehicle or component has been reported stolen. In a secure embodiment, each vehicular component has a public key, a private key, and an encryption algorithm. As will be appreciated more fully throughout this disclosure, the public key/private key encryption system allows an inventory of automobile parts to be conducted without transmitting through any publicly accessible channel the private key or the encryption algorithm associated with a particular vehicular component. This “public-key/private-key” design feature makes it virtually impossible to re-use stolen parts without detection, thereby eliminating not only vehicular theft, but even eliminating theft by “chop shops” which steal vehicles, and sell off the individual components thereof.

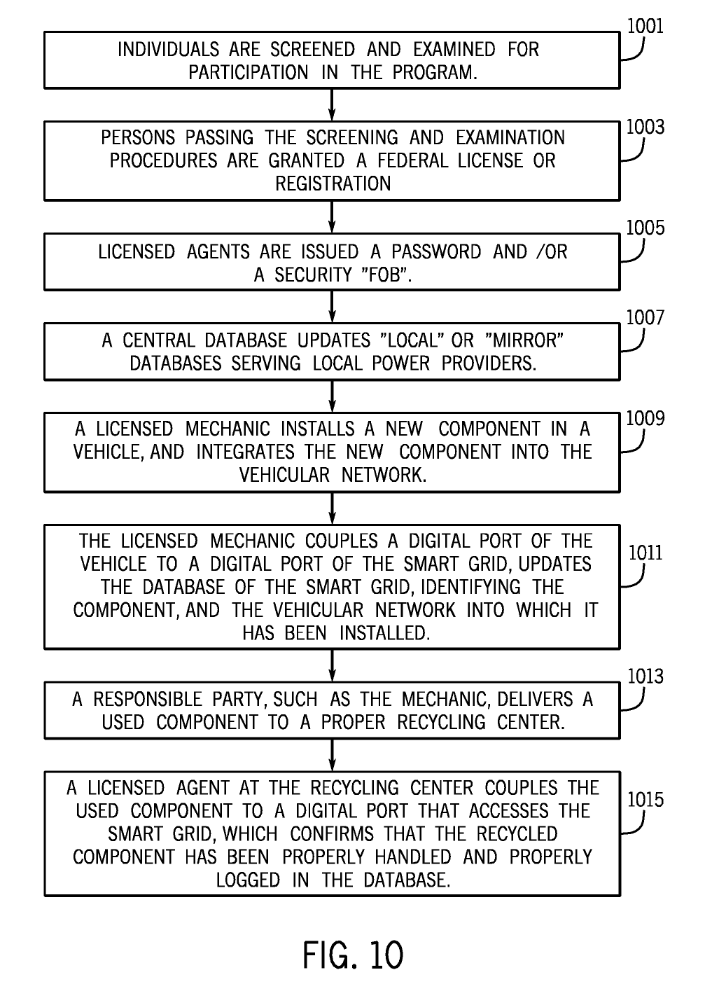

It is readily appreciated that the hacking of the data base could allow an auto thief to erase the previous record of a vehicle component, thereby allowing auto theft to occur with impunity. An advantage of a distributed database such as depicted in FIG. 3A is increased resistance to “hackers.” In a preferred embodiment, the local database 309-B includes a “read only” data storage member. For example, a compact disc which is updated daily would be impervious to system hackers. Alternatively, the local database may be stored on an erasable medium such as a hard drive, but wherein the “write mechanism” is “hardwired” to be inaccessible through internet access, and “write access” is limited in operation predetermined ports/interrupts/network components of the local computer/server. FIG. 10 illustrates a procedure by which a secure database can be updated by licensed mechanics while maximizing the integrity of the database from potential hackers.

In FIGS. 3A and 3B, the mirror database 309-B accesses the central server 300A, 300B at regular intervals to receive updates from the central database 309-A. The Central Server 300A, 300B includes an I/O communications port 321 and a processor 337 in functional arrangement, and may include a report generation module 320 in lieu of, or in addition to, the alarm generation module 311 in the local LDAPAC 113-A. Reports generated by the report generation module may include, but are not limited to, reports to local law enforcement agencies identifying the location of a stolen vehicle, or a vehicle containing stolen parts.

FIGS. 3A and 3B depict alternative embodiments showing varying degrees of smart-grid distribution, wherein functions may be performed at the local power provider 113A, 113B, or the central server 300A, 300B. The local LDAPAC 113-B includes a vehicle interface 301, a processor 303, and an I/O port interface 307 such as an Internet portal. The local LDAPAC 113-B is coupled the Central Server 300-Bvia a communication channel 317 such as the Internet. The central server 300-B includes a central database 309-A, a processor 337, an I/O interface 321 and a report generation module 320 in functional arrangement. A principle distinction therefore between the embodiment of FIGS. 3A and 3B is that the report generation module is localized in FIG. 3A, and a centralized in FIG. 3B. In the embodiment of FIG. 3-B, vehicle information is transferred via a communication channel 317 such as the Internet, from the local LDAPAC 113-B to the central server 302B. Data analysis and/or report generation are conducted by the central server 300-B. The distribution and/or redundancy of components across the Smart Grid is not limited to the database or a report generation module. The other components of the Smart Grid may also be distributed at diverse geographic locations, and may be redundantly duplicated.

Because many different distributed architectures are possible, the embodiments depicted in FIGS. 3-A and 3-B not intended to be comprehensive, but are offered simply to illustrate some of the potential alternative architectures of the DATRM 113 of FIG. 1. Those skilled in the art will appreciate that many derivative embodiments of the above architectures are possible, including multiple “central” databases which engage in mutual updating through sophisticated software, or “mid-level” servers which answer to a central server but govern a sub-portion of the network, such as a “LAN.”

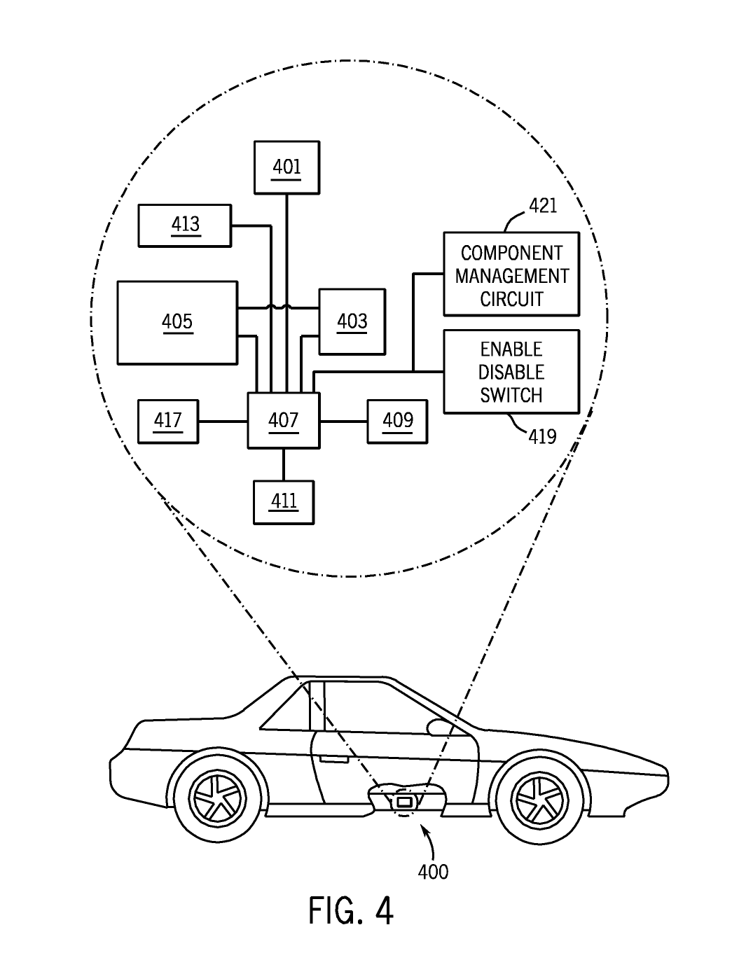

FIG. 4 depicts an embodiment of a vehicular component 400. For illustrative purposes only, the “first” component is described within certain examples of this disclosure as a vehicular chassis. This detail is not intended to limit the appended claims, which envision any component, or combination of components incorporating the features of FIG. 4, and any component being the “first” component in the handshake process.

Vehicular component 400 advantageously includes a digital componentry including a non-erasable Public Key 401, a non-erasable Private Key 403, a Encryption/Decryption Module 405 which contains an encryption/decryption algorithm. According to a preferred embodiment, the encryption/decryption algorithm is, at least in part, non-erasable. The digital componentry also includes a Processor 407, an I/O Port 409, a field for storing a network address 411, an enable/disable switch 419, a queue stack 413, a field 417 for writing an encrypted (or decrypted) response value, and a component management circuit 421.

Because components may be legitimately bought and sold, it is foreseeable that the network address 411 of a component may have to be reassigned. The network address of an electric motor and a first car may be, for example, a binary value 00010. A vehicular component could be legitimately sold and assembled in a second car, in which the binary value 00010 has already been used as a network address for some other component. According to a preferred embodiment, the data field used to store the network address 411 of a vehicular component is therefore stored in a writable data field. According to a first embodiment, the network address is erasable. If the first component is sold and assembled in a different vehicle, if necessary, the network of vehicular components can be erased, and a new network address written in the field.

According to a second embodiment, the network address 411 is stored in a digital field that is part of a stack of words reserved for a network address. A digital value can be written into each of these words only once, and not erased thereafter. Fusible links are an example of such “write once and only once” technology. According to this embodiment, if a vehicular component is sold and assembled within a different vehicle, and the new network assigns a different network address to the first vehicular component, and the new address is given priority over the previous network address. The last field containing a value greater than zero becomes the network address of that device.

According to a third embodiment, top-level system administrators (who have authority to determine the architecture of the lookup table of FIG. 6), may identify predetermined network addresses for various vehicular components. The following table is an example of a sequence of predetermined network addresses in conjunction with corresponding respective vehicular components.

TABLE 1

| | |
|---|---|
| 00000001 | Vehicular Chassis, left front |
| 00000010 | Vehicular Chassis, right front |
| 00000011 | Vehicular Chassis, left rear |
| 00000100 | Vehicular Chassis, right rear |
| 00000101 | Left Door |
| 00000110 | Right Door |
| 00000111 | Electric Motor |
| 00001000 | Internal combustion engine, gasoline |
| 00001001 | Internal combustion engine, diesel |
| 00001010 | Internal combustion engine, hydrogen |
| 00001011 | 12 volt battery for starting an internal |
| | combustion engine |
| 00001100 | 24 volt battery for starting an internal |
| | combustion engine |
| 00001101 | Battery pack, design 1 for driving an |
| | electric motor |
| 00001110 | Battery pack, design 2 for driving an |
| | electric motor |
| 00001110 | Digital motor controller for an electric |
| | motor used to power a vehicle |
| 00001111 | Alternator for charging a standard battery |
| 00010000 | Standard automotive Generator for |
| | charging a standard battery. |
| 00010001 | Generator for onboard charging of a |
| | battery pack |
| 00010010 | Onboard fossil fuel Reformate plant for |
| | generating hydrogen fuel |
| 00010011 | Auxiliary Component Interface |
| 00010111 | Etc. |

According to the foregoing embodiment, the digital value corresponding to the type of vehicular component is fixed by system administrators, and written into the non-erasable network address 411 field at the time of manufacture. The components of table 1 are not intended to be comprehensive, but only illustrative. The advantage to this embodiment is that there is never a need to reassign network addresses when new components are added to an existing vehicle. Sufficient address space can be allotted for new or even unforeseen components. Separate network addresses of distinct vehicular components to be sequentially addressed during the handshake process between the vehicle 101 and the Smart Grid 131.

The queue stack 413 is a sequence of addressable fields. Although embodiments are envisioned wherein they are erasable, according to the preferred embodiment, they are non-erasable “write-only-once” fields (such as fusible links) which permanently records a digital value when written. Although any value may be stored in the queue-stack, according to a preferred embodiment, the public key of a component is stored in a field of the queue-stack when a component is added to a vehicular network. Because components may be subsequently removed from the vehicle, reported stolen, or have theft issues resolved, each field within the queue stack advantageously comprises a plurality of status bits corresponding thereto. The status bits may be used to indicate a variety of status issues, including, but not limited to, indicating that a component has been removed from the vehicle and is no longer part of the network, a reported theft of a component, etc. The circuitry permitting updating the status of a component (writing a status flag into a status bit) is preferably protected to prevent hacking. Protection can be achieved by requiring a challenge and an encrypted (or decrypted) response by the smart grid, thereby ensuring that all status changes are approved by the smart grid. The challenge would preferably include the public key of the component in which the queue stack is located, and would require a response using the private key and encryption code of that component.

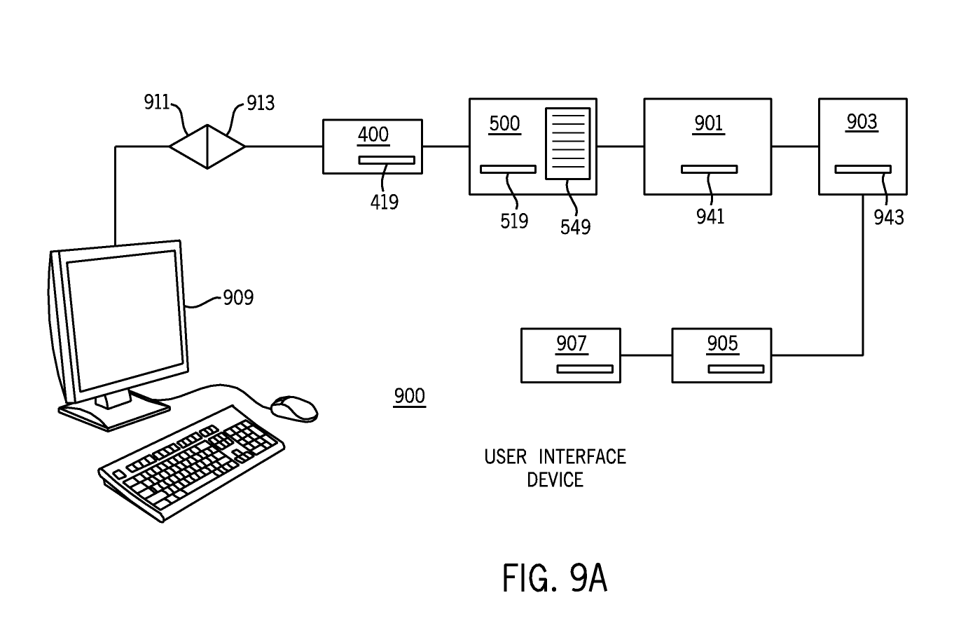

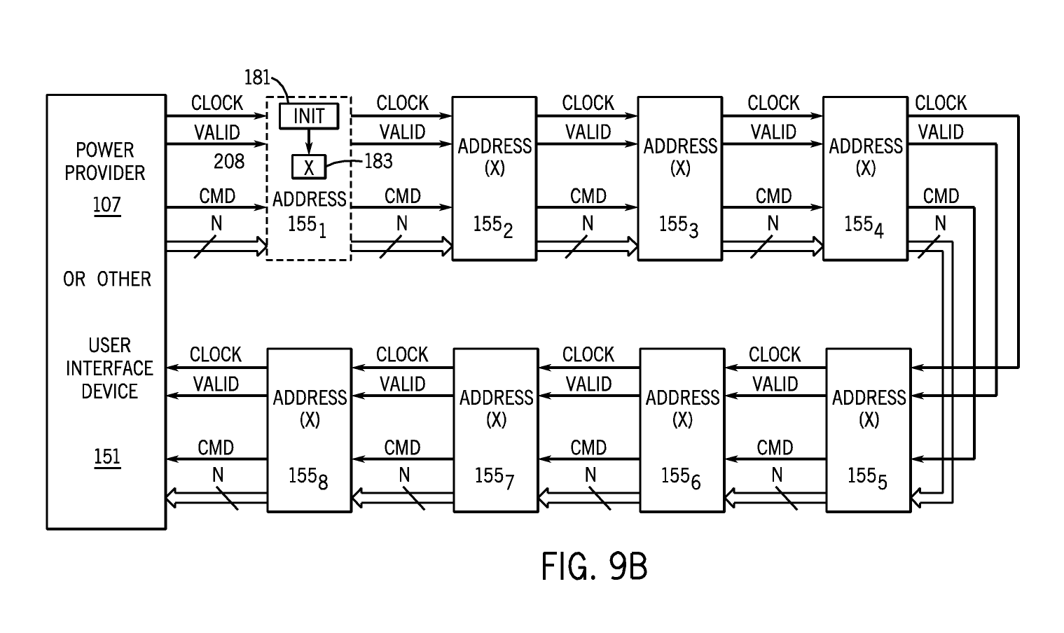

The security advantages can be appreciated by the following example. During the repowering process, in a hand shake between the vehicle and the smart grid, the vehicle transmits a list of public keys representing the components within the vehicle. Automobile thieves might attempt to circumvent other safeguards described herein by disconnecting a stolen component from the automobile signal bus “N” (FIG. 9-B) prior to pulling into a repowering station (or prior to traveling beneath a bridge or check point known to document vehicular components). However, by writing the public key of every network component into the queue stack 413, even if a thief attempted to “unplug” a stolen component before re-powering the vehicle, the public key of the stolen component will still be transmitted during the hand shake process.

To avoid detection therefore, car thieves will naturally want to avoid integrating a stolen component into the vehicle's network. If possible, therefore, a component should be manufactured such that it will not function if not integrated with the vehicle's network. For example, most doors have electric windows, and can be unlocked by a hand held signal generator that consumers keep attached to their key rings. It is therefore preferable to manufacture a door such that the functionality of the lock and the window are disabled if the door is not integrated into the vehicle's network.

Additionally, the smart grid should be programmed to recognize when a “critical component” is missing from a vehicle. If vehicle 101 appeared at a repowering station one day and the left door failed to respond to a challenge and response from the grid, the absence of the left door indicates a possibility that a stolen door has been installed, but not coupled to the vehicle's network. The grid may be programmed to respond, for example, by initiating a thirty day timer. If, at the end of thirty days, the vehicle still shows no evidence of having a left door, appropriate measures are taken, such as notifying law enforcement authorities of the likelihood that a stolen auto part has been installed on the vehicle.

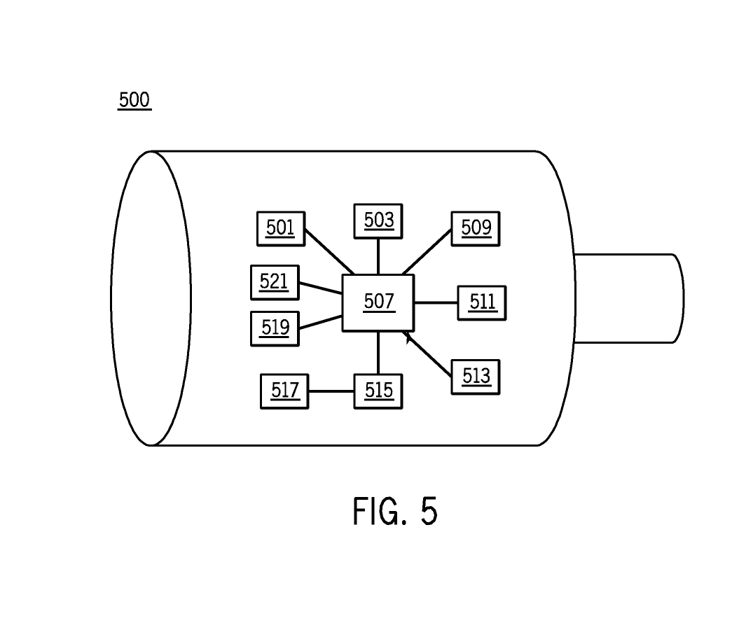

FIG. 5 depicts second vehicular components 500 that also includes a Public Key 501, a Private Key 503, an Encryption/Decryption Module 505, a Processor 507, an I/O Port 509, a field 511 for storing a network address, a field 517 for writing an encrypted (or decrypted) response value, a queue stack 513, an enable/disable switch 519, and a component management circuit 521. The depiction of this element as an electric motor is not intended to limit the appended claims to any single type of vehicle. Internal combustion engines, battery powered electric vehicles, fuel cell driven electric vehicles, and even steam ships and other power driven transportation devices are envisioned within the appended claims.

The reader will appreciate that switch 419, 519 maybe a multifunction switch, and not limited to simply enable and disable functions. Other potential selection modes include, but are not limited to, economy mode, performance mode, racing mode, diagnostic mode, and recording mode. The recording mode would be particularly useful, for example, in a home with a teenage boy given to fast or reckless driving. A parent could lock switch 419, 519 in the recording mode. Performance data could be written into the memory area (not shown) for later retrieval by the parents. Data could include, but is not limited to, speed, acceleration, braking, and G's experienced in cornering. In addition to recording this raw data, embodiments are envisioned in which data points are accompanied by a timestamp indicating the exact time of the high speed or high acceleration activity, and the GPS coordinates. This data would allow parents to reconstruct the activity of their children to ensure sound driving technique. Such recorded data can also be used for accident reconstruction, or to confirm the location of a vehicle at a time of a suspected robbery or crime.

It can be readily appreciated that the recording mode is not exclusive of other modes. For example, the vehicle could be set for “economy mode” and “recording mode” when a teenager is driving it, thereby both controlling the behavior of the young person, and recording it as well. In contrast, the vehicle owner may be a racing enthusiast. As a consequence, when out at the track racing is vehicle, the owner would want to vehicle set for “racing mode” and “recording mode.”

Although certain digital features described herein are envisioned as “read only” to prevent tampering, it will be readily appreciated that at least some of the component management circuit 421 can be “read/write”, thereby allowing engineers, mechanics, and racing to enthusiasts to “tune” their vehicles.

According to a preferred embodiment, the ongoing functionality of these vehicular components requires digital enablement, and a failure to provide a proper digital handshake during certain operations will result in the disablement of the vehicle, or certain components therein. The various digital keys, modules, and components depicted in FIG. 400 are physically embedded at a transistor level, and not simply a software level, and are so tightly integrated with the operation of the component that they are virtually inaccessible to “hackers.” Moreover, they are preferably configured such that any attempt to tamper with, disable, or circumvent the digital safeguards results in the disabling of the vehicular component as well. For example, a motor controller may be used to govern the speed, acceleration, and other behavioral characteristics of electric motor driving an automobile. Some of the referenced digital components could be formed within the same integrated circuit die which included a program for governing the electric motor.

FIG. 6 depicts a lookup table 600 which according to an embodiment, is in the form of a digital database. The table is conceptually depicted as a plurality of rows and columns. Each row represents a different vehicle. Each column represents a different data representation relating to the vehicle represented by that row. Those skilled in the art will appreciate that digital addressing schemes are typically used in digital data bases to associate, in digital format, diverse digital data fields grouped in a common “column” as well as digital data fields grouped in a common “row.” Accordingly the terms “column” and “row” refer not only to the depiction of FIG. 6, but also, to addressable fields in a digital data table that are related by addressable features.

The first column 601 comprises the vehicle identification number (VIN) of a plurality of vehicles. The row initialized by each VIN represents a different vehicle, and the data in that row represents vehicular data related to that particular vehicle. Although the following example identifies vehicular components and features relative to a VIN, it is really appreciated that any vehicular component (e.g., electric motor, a battery pack, etc.) may be used to identify the vehicle, with other components identified relative to that first vehicular component. Accordingly, the term “VIN” can be understood as functionally equivalent to a preselected “master” number, such as the public key of the chassis. Embodiments are envisioned in which no vehicle or component is preselected as the “master” component. However, according to the preferred embodiment, a VIN or Master component is identified for every vehicle, thereby increasing the efficiency of searching the database of the Smart Grid.

The first row represents a first vehicle, identified by VIN-1, the second row represents a second vehicle, VIN-2, etc. Table 600 represents a database of vehicles and respective components which have been registered with a “smart” dynamic database used to track vehicles.

The second column 603 contains a plurality of digital fields representing a corresponding plurality of Vehicle Theft Status Flags 603-VIN-1, 603-VIN-2, etc. Although the status flags of column 603 are represented by a single bit (shown as either a “0” or a “1”) those skilled in the art will readily appreciate that a multi-bit field could be used for such flags, and that such multi-bit field could thereby indicate a variety of statuses. A car which is reported stolen for example may have been towed be by law enforcement authority. A multi-bit flag be used to identify this “indeterminate” status, pending confirmation by the police that no towing had occurred, and that the vehicle was indeed stolen. Such status flags could also direct law enforcement authorities to remarks or other data associated with the vehicle, such as “vehicle ownership has been subject to dispute in a divorce,” or “infant was reported to be in his vehicle at the time it was reported stolen.” Throughout this disclosure, therefore, it will readily be appreciated that a “flag” or “alarm” can represent a multi-bit field as well as a single bit field. It will be further appreciated that, in representation of a single bit field, the meaning ascribed to a digital value of zero or one is arbitrary, and could be reversed.

Each field in column 605 contains a “public key” of a first vehicular component corresponding to the vehicle of that particular row, and each field in column 607 contains the “private key” of the first vehicular component corresponding to the vehicle of that particular row. Each field of column 609 contains a digital value identifying the encryption algorithm embedded within the corresponding vehicular component. Columns 611, 613, and 615 similarly have the public keys, private keys, and encryption algorithms of a second vehicular component. Lookup table 600 may include a listing of any number of vehicular components, terminating at the N^{th} vehicular component. Since not all vehicles will contain the same components, the fields within columns 603, 605, and 607 associated with vehicle VIN-3 contain a default value indicating the vehicle VIN-3 does not contain this automobile part.

In an embodiment, each row is reserved for a specific type of vehicular component. For example, columns 605, 607 and 609 would be limited to electric motors. Columns 611, 613, and 615 would be reserved for battery packs. Other components which could be listed in the table include, but are not limited to, fuel cells, chassis, internal combustion engines, transmissions, alternators, generators, radiators, differentials, GPS devices, stereo and radio equipment, etc, as well as maritime components found on merchant vessels and steam ships.

In alternative embodiments, a single column may, through a succession of different vehicles, identify a plurality of different types of vehicular components. For example, columns 605, 607 and 609 could contain data relating to an electric motor in relation to vehicle VIN-1, and data relating to an internal combustion engine or vehicle VIN-2. In such embodiments incorporating an “eclectic” use of columns within the lookup table 600, an initializing handshake would advantageously search all of the “public key” columns (e.g. columns 605, 611, etc.) to identify a match for the publicly received the digital handshake. If a comprehensive search of the lookup table 600 were conducted each time a vehicle was examined for potential theft, a preset order of components would not be necessary in the lookup table, but the searching time could be increased.

To compare encrypted or decrypted values, the same (or “minor image”) encryption and decryption modules must reside in both a vehicular component, and the Smart Grid 131. An encryption module can exist at the “hard wired” level in the form of transistors and other fixed circuit components, or may exist as an erasable program in a RAM or other erasable medium. In either event, such circuitry/programming depicts at a “machine level,” an encryption algorithm described in conceptual or mathematical terms. Accordingly, the terms “encryption algorithm” and “encryption module” are used interchangeably throughout this disclosure.

The Smart Grid will advantageously store a plurality of encryption modules matching (or “mirroring”) all existing encryption algorithms operating in vehicular components. Because additional encryption algorithms are modules can be downloaded and stored within the Smart Grid at any time, additional encryption algorithms can be added at any time to vehicular components, facilitating upgrades, and/or diversity of encryption algorithms, while maintaining unfettered functionality of vehicular components utilizing legacy encryption algorithms and systems.

System flexibility can be further illustrated in conjunction with the third vehicle VIN-3. According to an embodiment in which column 605 is reserved for the public key of a particular type of vehicle components, FIG. 6 depicts a default digital value within the public key, private key, and encryption algorithm relating to the first vehicular component of vehicle 3 (VIN-3). The default digital value 000000 indicates that no such value has been registered in conjunction with vehicle VIN-3. This may be because vehicle VIN-3 does not have an electric motor, or because vehicle VIN-3 was manufactured prior to implementation of the security system described herein. Through the use of such default values in the lookup table, the security methods and devices described herein may be gradually “phased in” to a free-market system over a period of time while accommodating vehicles designed prior to the implementation of the security system described herein. A vehicle 101 manufactured prior to the implementation of the digital marking and tracking system described herein, can be serviced at a re-powering station that screens newer vehicles and vehicular components for theft.

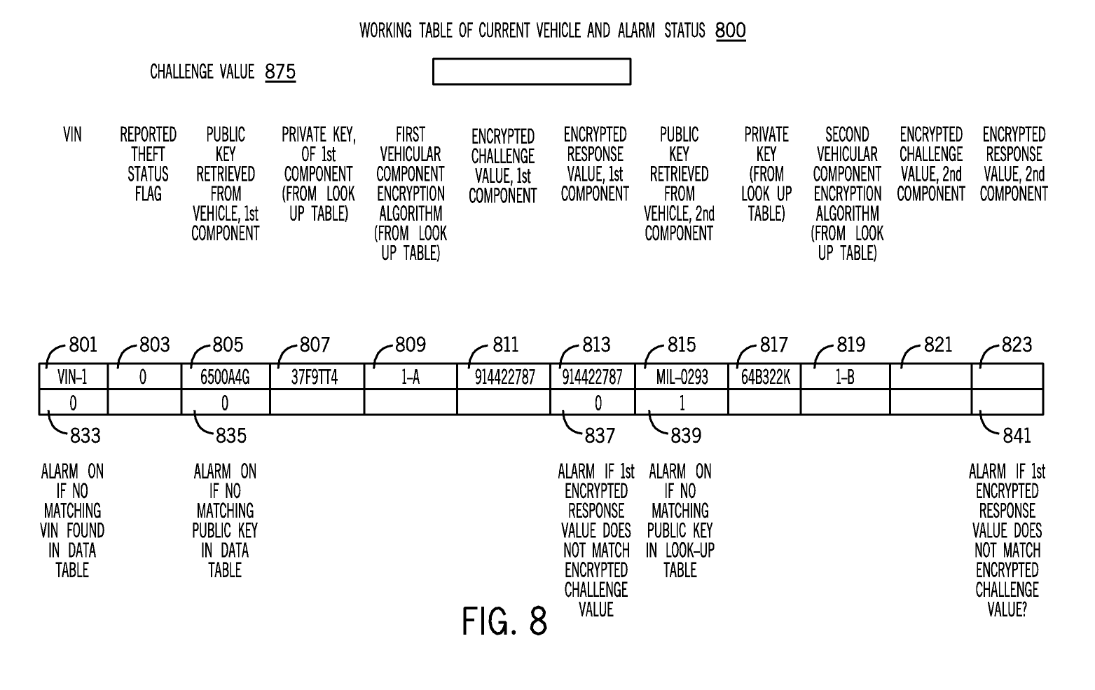

Because the data in table 6 is used to generate vehicle theft reports, secure access to this table is essential. On the other hand, auto mechanics must be able to change other parts of the vehicle. According to an embodiment, a screening and selection process limits the access to the lookup table to registered mechanics. Confirmation of the identity of the mechanic preferably includes a variety of secure features to prevent criminal or otherwise unauthorized access to the data table. The process described in conjunction with FIG. 8 incorporates a variety of security measures to prevent “hacking” of the database by unauthorized agents. low-level security measures to require an ID and password of a registered mechanics.

FIG. 7 describes an embodiment for determining whether a vehicle is stolen, and taking appropriate action in light of that determination, including initiating various reports and messages to law enforcement authorities, terminating the re-powering process, disabling the vehicle, etc. Although the specific details describing the process in FIG. 7 include encryption/decryption techniques, it will readily be appreciated by those of ordinary skill in the art that the principles described in conjunction with FIG. 7 can be implemented without encryption, and that the use of an encryption/decryption process is offered as an alternative embodiment offering an increased level of system security.

The handshake process between vehicle between the vehicle 101 (including specific vehicular component 400, 500) and the Smart Grid 131, described herein may be initiated by either the vehicle or the Smart Grid. Specific details wherein the handshake is initiated by a particular one of these two entities are therefore offered for illustrative clarity, and are not intended to limit the spirit and scope of the appended claims.

The reader will advantageously also refer to the look-up table of FIG. 6 in conjunction with the process described in FIG. 7.

In the following example, reference may be made to an electric car that runs on an electric motor, wherein a storage batter provides power for its power, and wherein the potential energy medium used for re-powering a vehicle is electricity. These limitations are offered for clarity of explanation in conjunction with FIG. 7, and are not intended to limit the spirit and scope of the appended claims, which envision alternative types of vehicles, and even merchant vessels and steamships.

In step 701, a first vehicular component is manufactured, which can be an electric motor, chassis, or other vehicular component. The manufacturing process includes embedding two unique digital IDs in the electric motor, a public key, and a private key, as well as an encryption/decryption module and a queue stack. Referring to FIG. 6, the public key of the first vehicular component is 6500A4G.

In step 703, a second vehicular component is manufactured. The manufacturing process includes embedding two unique digital ID in the second vehicular component, a public key, a private key, and an encryption/decryption module. According to the example depicted in FIG. 6, the public key of the second vehicular component is G144079. The reader will appreciate that vehicular components embedded with unique digital IDs may include, but are not limited to, electric motors, battery assemblies, sub-assembly battery components, ultra capacitors, fuel cells, hydrogen storage units, petrochemical storage tanks (such as a gasoline tank of an automobile, the fuel tank of a merchant vessel), internal combustion engines, steam turbines, jet engines, ramjets, one or more components of a vehicle chassis, one or more components of the hull of a merchant vessel, alternators, generators, steering mechanisms, breaking mechanisms, transmissions, electronic navigation systems, electronic engine management systems, electronic entertainment systems, etc. The reader will further appreciate that, although the lookup table of FIG. 6 depicts a small number of vehicular components, the lookup table of FIG. 6 may include any number of vehicular components.

In step 705, vehicle 101 of FIG. 1 is assembled, including the first and second vehicular components, which are installed in the vehicle, and coupled to the vehicle's network bus. Each component is assigned a “network address” or “network ID”.

In step 707, the public key of every component in the vehicle's network is recorded in/on a non-erasable medium in the queue stack of a select component, such as the queue stack embedded in the vehicle chassis. According to a preferred embodiment, a component will not operate unless it has been assigned a network ID, is currently on the network bus, and/or has had its public key registered on the queue stack of a designated component.

In step 709, the vehicle operates for some time, including re-powering at a Power Provider (re-powering station/fueling station) according to the steps described herein.

In step 711, a portable device such as a GPS is manufactured, including a public key, private key, and encryption/decryption algorithm, is installed in the vehicle. FIG. 9B a process by which network addresses are assigned to components. FIG. 13 describes an embodiment wherein the vehicle comprises digital ports 1301 that allow portable devices to connect to the network. A preexisting auxiliary component interface 1303 has a pre-assigned network address (or multiple addresses), and can multiplex multiple portable devices onto the network. By the following example, the reader will appreciate that even a removable automotive device, such as a GPS, can be “theft-proofed” by the methods and apparatuses described herein. It will be readily appreciated that this same anti-theft protection is afforded all network components, both portable (such as a GPS device) and permanent (such as the electric motor powering the vehicle). FIGS. 14-16 describe how the methods and apparatuses described herein may be used to afford anti-theft protection to non-automotive portable devices that can operate outside of a vehicle, such as a notebook computer or cellular telephone.

In step 713, the portable device is assigned a network ID, and the public key of the portable device is non-erasably recorded in the queue stack of the chassis.

Redundant Queue Stacks

Recalling that the location of the queue stack is not limited to the chassis, embodiments are envisioned in which redundant queue stacks are installed in multiple vehicular components. To avoid redundant communications between every queue stack and the smart grid, a particular component (e.g. the chassis) can be assigned the “primary component” status, and all other “redundant” queue stacks in other components simply defined as redundant, and configured to operate differently from the primary queue stack. In an embodiment, during a digital handshake with the smart grid, the primary queue stack performs a cyclical redundancy check (or a similar process) that is based on an aggregation of all of the public pairs of components listed therein. The challenge and response for the primary component may include transmitting the CRC or an encrypted value of the CRC derived from those public pairs. The redundant queue stacks would each perform a CRC of the components listed within them. The results would presumably be identical since the list of components is identical in all of them. Those respective components would then encrypt their respective CRCs according to their respective private keys and encryption algorithms. The transmission from the vehicle to the smart grid could therefore include the public key of every component, and the encrypted CRC of those components housing redundant queue stacks. When decrypted within the smart grid, all of the CRCs should match each other, and should match the primary CRC. If not, evidence of hacking may be present, and the vehicle and/or smart grid could be programmed to take any action deemed appropriate. As discussed above, status bits within the queue stack would advantageously indicate if a component had been removed from the vehicle. A used component that was installed in a vehicle would therefore, by status flags, identify components in its queue stack which were associated with its “previous” vehicle, and no longer associated with the vehicle in which the component was installed. The active components in the “new” vehicle would be written into the queue stack of the replacement part. Accordingly, when generating a CRC, a redundant queue stack will use only the public key of components currently installed in the vehicle, insuring that all redundant derived from the same aggregation of public keys.

Stuffing the Queue Stack

One technique of automobile thieves to circumvent a queue stack record of components installed in a vehicle could be to “stuff” a queue stack . . . to install and uninstall a sequence of components to fill the queue stack, so that additional components are not recorded. Several safeguards could be incorporated to prevent this: 1) A queue stack could be extremely large, sufficient, for example, to hold one hundred thousand public pairs or more, making it almost impossible to install and uninstall components often enough to stuff the queue stack. 2) A timer could require that a component be installed for a minimum amount of time, e.g. one hour, before its public key was written into the queue stack. Rapid installation and removal of components would therefore fail to be recognized by the queue stack, thereby preventing stuffing of the queue stack. 3) Because of the capacity of a queue stack, it can be assumed that if a queue stack were ever “filled,” it would be for the exclusive purpose of attempting to conceal stolen components. In an embodiment, therefore, a “stuffed queue stack” will either disable the vehicle immediately, or wait until it is recharged and in communication with the smart grid, and then disable the vehicle and report the condition to the smart grid, along with any relevant information it is programmed to communicate to the smart grid. The smart grid will then generate a theft report to the appropriate law enforcement agency/agencies, and take any other steps that are appropriate.

In step 715, the vehicle pulls into a re-powering station to re-charge or re-fuel. As noted above, the re-powering process comprehends alternative processes, including refueling with fossil fuel or hydrogen fuel, as well as electrically recharging batteries, capacitors, or other power sources used for storing electrical charge. Moreover, the depiction of the vehicle in FIG. 1 as an automobile is offered for illustrative clarity. Within the appended claims, the use of the term “vehicle” fully comprehends other transportation devices, including, but not limited to, trucks, boats, planes, armored military vehicles, unmanned military drones, merchant steam ships and motorized vessels, etc. The embodiments described herein therefore have application for anti-piracy protection of merchant vessels and steamships.

In step 717, the input node 103 of the vehicle is coupled to the output node 127 of the Power Provider. The input node can variously be configured to receive a chemical potential energy medium or an electrical potential energy medium. Commensurate with the alternative embodiments of the input node, the output node 127 of the Power Provider can be configured to provide a chemical or electrical potential energy medium.

In a preferred embodiment, the input node 103 of the vehicle is also configured to exchange information with the Smart Grid 131 by means of information signaling. For purposes of illustration only, information signaling described in FIG. 7 is envisioned as an electrical digital signal, and is transmitted across a signaling path of the energy transfer line 105.

In embodiments in which the potential energy medium is electrical energy, the energy transfer line 105 is a conductive power cable. Although embodiments are envisioned in which electrical power is transmitted through a conductive channel separate and distinct from the conductive path used in the digital handshake process, according to preferred embodiment, information signaling is conducted across the energy transfer line 105 and super-positioned on a power signal. Alternative embodiments are envisioned in which some, or all of the information signaling described within this disclosure is transmitted across an information highway 157 distinguishable from the energy transfer line 105. In any embodiment not using RF transmitters or tags, step 717 includes the coupling of the digital network of the vehicle to the Smart Grid.

In Step 719, the vehicle engages in a digital handshake with the Power Provider. According to an embodiment, the vehicle is disabled during the initialization of the handshake to ensure that it cannot drive off with a charging cable or hydrogen hose attached. The disabling may be initiated by the Smart Grid or the Vehicle. In an alternative embodiment, the vehicle operator must disable the vehicle before or after coupling with the Smart Grid. Either the vehicle, the Smart Grid, or the operator may initiate the hand shake.

In Step 721, during the digital hand shake, all of the public keys stored in the queue stack are transmitted to the Smart Grid. In an alternative embodiments, the public keys may be transmitted “en masse” (in a single digital transmission), or seriatim in a series of transmissions that are interrupted by responses from the Smart Grid. The transmission of public keys to the Smart Grid may be initialized by the individual components, or initialized by a single device, such as, by way of example, a queue stack embedded in the vehicular chassis which has a record of all of the Public Keys that have ever been part of the vehicles digital network.

The reader will further appreciate that, in conjunction with the process disclosed in FIG. 7, the public key associated with a vehicular chassis or some other vehicular component, can function as a VIN, and the VIN number of any particular vehicular component VIN is fundamentally one of “consensus,” prioritizing one vehicular component as a “central” vehicular component. Accordingly, the process disclosed in FIG. 7 may be understood equally as including the digital transmission of a VIN, or not involving the digital transmission of a VIN.

In step 723, the Smart Grid selects the first Public Key (e.g. the VIN) for examination searches for the Look Up table for a match of the selected Public Key, and selects the first Public Key (e.g. the VIN) for examination. The lookup table 600 of FIG. 6 depicts an example of the look-up table being searched. To enhance network security, this search is preferably directed to a “mirror” look up table, thereby limiting access to the central look up table. However, embodiments are envisioned in which the central lookup table is searched, depending on system architecture.

In step 725, if a matching Pubic Key is found in the look up table, then in Step 727, the Smart Grid examines the Theft Status flag associated with the VIN and optionally, writes it into the working table.

In step 731, if the Theft Status Flag is asserted, then in step 733, the Smart Grid initiates a “hard response.” A hard response may include, but are not limited to, generating and/or transmitting a report to law enforcement authorities, disabling one or more components in the vehicle 101, disabling the Power Provider 107 from refueling or recharging the vehicle 101, initializing photographic sequence or video camera 123 at the local re-powering station (FIG. 1) and attempting to photograph the driver, the vehicle, and/or the license plate), or combinations of these actions.

In step 731, if the Theft Status Flag is not asserted, the process advances to step 733.

In step 725, if no matching Public Key is found, the Smart Grid asserts a “non-registered vehicle” flag and generates a message to system administrators and law enforcement. According to step 734, the Smart Grid may run a risk-assessment algorithm to determine the appropriate response. If the Risk Assessment Algorithm determines that re-powering is not authorized, then in Step 733, the Smart Grid executes a “hard response” which may include passively leaving the vehicle in a disabled state (refusing to re-enable the vehicle), summoning law enforcement authorities, activating an automated camera as shown in FIG. 1, or combinations of these actions. If, in step 734, re-powering is authorized, the process advances to step 735.

Upon receiving the transmission from the vehicle 101, the Smart Grid 131 writes of this data into Working Table 800. The reader will appreciate that the depiction of certain items in table 800 is partially presented for illustrative clarity, and that values depicted in the lookup table 600 of FIG. 6 may not need to be duplicated in another table. The Working Table 800 may be formed in a volatile or non-volatile memory area. Data received from the vehicle may include, but is not limited to, a VIN, and the Public Keys of the various vehicular component.

In step 735, The Smart Grid identifies, within the Look-Up table, the encryption algorithm and the private key corresponding to the component (i.e. the public key) under Examination.

The reader will further appreciate that the recitation of a “public key” does not require that any of the vehicular components also have a private key. Partially-encrypted embodiments are envisioned, wherein some of the vehicular components have a public-key and a private key, and other vehicular components have only a public key, and lack a private key. Non-encrypted embodiments are also envisioned, wherein none of the components identified by the hand shake process have a corresponding “private key.”

In step 737, the Smart Grid generates a challenge value. The challenge value may be derived from any source, including, but not limited to, a random number generator, date and time stamps associated with the transaction, a merchant number of the local Power Provider 107 station, etc.

In step 739 The Smart Grid Encrypts the Challenge Value according to the encryption algorithm and private key of the component being evaluated, generating an Encrypted Challenge Value

Referring briefly to FIG. 8, flag 803 indicates that a theft has actually been reported in conjunction with a specific VIN or Public Key. Other flags or alarms indicating potential theft include, but are not limited to, “No Matching VIN” 833, “No Matching Public Key” 835, 839; and “Non-matching Private Key 837, 841. System administrators can configure a variety of actions to be performed in response to a flag or alarm. These responses are referred to herein as “soft responsive” and “hard responses.” A “soft response” is preferably implemented when an analysis of an alarm and associated vehicular data suggest that a theft is possible, but unlikely. Soft responses may include, but are not limited to, notifying an owner or registered mechanics about an irregularity with a particular part, initializing a timer (or generating a date/timestamp) representing the time at which the irregularity was first noticed, or incrementing a counter each time the irregularity is observed (e.g., the time the vehicle is re-powered). A “hard response” is preferably implemented when system administrators (or system algorithms) suggest that a likelihood of vehicular theft exceeds a predetermined minimum threshold. The alarms and/or flags depicted in FIG. 8 are offered as examples. Flags and alarms may be a single bit value, or a multi-bit value.

Law enforcement agencies receiving stolen vehicle reports may include, but are not limited to, private security agencies, city or state police, federal government agencies, or combinations thereof. In an embodiment, law enforcement agencies are selected according to their geographic proximity to the local Power Provider in which the vehicle is attempting to re-power, thereby enabling rapid response by law enforcement authorities.

A Theft Analysis Algorithm for determining if a response should be hard or soft, preferably takes into consideration the nature of the alarm. For example, a “reported theft” alarm 803 will almost certainly generate a hard response, whereas a “No Matching VIN” flag 833, a “No Matching Public Key” flag 835, 839, or an improper response to a challenge value is received a 37, 841 may initiate a soft response if system administrators determine that the probability of vehicular theft is unlikely. An algorithm for selecting between a hard and soft response may also include location of the vehicle. For example, if the vehicle is refueling at a location associated with a heightened alert status for vehicular theft, a flag or alarm may be more likely to result in a hard response. The nature of response may also be influenced by the value of a timer or date/timestamp associated with a vehicular component (e.g., how long has it been since the alarm was initialized?) or the value of a counter (or many times is the vehicle refueling or been recharged since the irregularity was first noticed). Additionally, individuals known or suspected of automobile theft may be flagged within the database. An irregularity with a VIN a vehicular component will produce a higher probability of a “hard response” if the person refueling the vehicle has been flagged in the database. An analysis of the foregoing data, or any combination thereof, will advantageously be included in an algorithm determining the appropriate system response to an irregularity.

Spatial limitations in FIG. 6 prevent display all of all of the different types of data which can be represented within the lookup table 600. In an embodiment, each “row” of the lookup table includes a field for storing an address or pointer. The address or pointer is thereby able to draw a correspondence between the vehicle represented by a certain row of the lookup table, and another part of the database. The data associated with a vehicle, is therefore unlimited. Data associated with a vehicle may include arrest warrants, “Megan alerts” (police reports of potential kidnapping of child abduction), recall notifications warning a driver about a potentially unsafe part, medical history of a driver or passenger (e.g., drug allergies). Appropriate reports and the transmitted to law enforcement authorities, family members, mechanics, or any other persons designated within the system. The Look-Up table, or some other data base of the Smart Grid, will preferably record “time and date stamps” of the first time a component is observed within a vehicle by the smart grid. This will assist in resolving disputes and investigations relating to theft and disputed ownership of vehicular components. Because of spatial limitations, time and date stamps are not shown in FIG. 6.

Step 741 depicts alternative encryption and decryption processes. As discussed above, the encryption process itself is optional, and embodiment are envisioned in which “private keys” do not even exist.

In step 743, the Smart Grid transmits a digital packet to the vehicle which includes the challenge value corresponding to the vehicular component under examination.

In step 747, the vehicular component encrypts the challenge value utilizing its encryption algorithm and private key, generating an encrypted response value.

In step 751, the vehicle transmits the encrypted response value to the Smart Grid.

In step 755, the Smart Grid compares the encrypted response value to the encrypted challenge value.

Alternatively, following step 741, in step 745, the Smart Grid transmits a digital packet to the vehicle which includes the Encrypted challenge value corresponding to the vehicular component under examination.

In step 749, the vehicular component decrypts the encrypted challenge value utilizing its decryption algorithm and private key, generating a decrypted response value.

In step 753, the vehicle transmits the decrypted response value to the Smart Grid.

In step 757, The Smart Grid compares the decrypted response value to the challenge value.

Following either of the alternative processes terminating at step 755 or 757, in Step 759, if the values fail to match, then in step 761, assert an “Invalid Encryption Challenge” Flag. An example of this is found in the flag/alarm field 837, 841 corresponding to the vehicular component. The “Invalid Encryption Challenge” flag may indicate that a vehicular component has been stolen, and an attempt has been made to “hack” the encryption and security system of the components.

In step 763, the Smart Grid assesses the probability of theft.

In step 765, of theft appears likely, the Smart Grid assert a “Hard Response” (generate a notice to law enforcement, and disable vehicle or maintain in disabled state.

If, in Step 759, the value encrypted (or decrypted) by the vehicular component matches the value generated by the Smart Grid, then in Step 767, the Smart Grid inquires whether there are any other public keys received from the vehicle that have not yet been examined. Although the preferred embodiment envisions a “bulk” transmission of all Public Keys, alternative embodiments are envisioned in which Step 767 includes an inquiry by the smart grid as to whether or not the Vehicle has any other Public Keys.

If no Public Keys remain to examine, than in Step 769, the Re-Powering Process begins. When Re-powering is completed and nozzle is returned to unit, unlock (re-enable) vehicle

If, in step 767, additional Public Keys are identified, then in step 771, the Smart Grid select the Next Public Key received in the transmission from the vehicle.

In step 773, the Smart Grid searches the current “row” of the Look-up table (that is, the row associated with the vehicle 101 being re-powered) for a matching Public Key.

In step 775, if a Matching Public key is found in the Vehicle's “Row”, then the process returns to step 735.

In step 775, if no Matching Public key is found in the Vehicle's “Row”, then, in step 777, the Smart Grid searches other Rows of the Look Up Table for the Public Key under examination.

In Step 779, if no matching key is found in any other “row” of the Look-Up table (that is, the component is not associated with some other vehicle), then in step 781, the Smart Grid records the Public Key, Private Key, Encryption Algorithm and Date Stamp of the new component in the data “row” of new vehicle 101. (That is, the smart grid associates the new public key with the vehicle being re-powered.

If, in step 779, a matching key is found in another “row” corresponding to another vehicle, then, in step 783, the Smart Grid searches for a “Theft Alert” associated with the component in question. In a embodiment in which the component was stolen from another vehicle, the Theft Alert will be in the “row” associated with the vehicle from which the component was stolen. However, used parts may be purchased, stripped from their respective vehicles, warehoused, and stolen from the warehouse. Embodiments are therefore envisioned in which the Smart Grid includes a general data base of stolen components, whether or not they were stolen from a particular vehicle. Step 783 fully comprehends these alternative circumstances.

If, in step 783, a theft alert has been posted, then in step 785, the Smart Grid asserts a hard response, such as notifying law enforcement authorities, and disabling or refusing to re-enable the vehicle at the re-powering station.

Because the re-powering of a vehicle is typically accompanied by a financial transaction (e.g., a credit card, debit card, etc.), hard responses will advantageously include the steps of identifying credit and debit card accounts associated with the driver, and forwarding a request for user data to the corresponding financial institutions. Such data may provide law enforcement authorities with aliases, alternative addresses, and other relevant data. In one embodiment, the data is sent from the financial institutions to the Smart Grid, and then retransmitted to law enforcement authorities. In an alternative embodiment, the Smart Grid requests the financial institution to contract a law enforcement agency, and provides the financial institution with some necessary data to initiate a police investigation. The financial institution then transmits appropriate information to an appropriate law enforcement agency.

Throughout the process of FIG. 7, the Smart Grid writes, into the appropriate fields of the working table 800, the encryption algorithm (FIG. 6, columns 609, 615, 629) and private key (FIG. 6, 607, 613, 629) corresponding to the public key undergoing examination.

System response to the presence of an “unregistered component” or other irregularities depends on system history as interpreted by system administrators and programmed in the Smart Grid. A reminder message to a mechanic may be required. An inquiry to the vehicle owner may be appropriate. A request for a police drive-by may be in order. These responses are configured by administrators of the Smart Grid, and preferably in conformity with the collection of data that identifies patterns and probabilities of circumstances surrounding the discovery of a non-registered component.

As discussed above in conjunction with Table 1, embodiments are envisioned wherein the network address of at least some of the vehicular components are predetermined according to the type component. It will be readily appreciated, however, that a flexible system will need to make exceptions to this model. For example, an engineer may design and “off-road vehicle” having two or more electric motors operating independently. Alternatively this seem redundant design might be useful in military applications in which the motor could be disabled in a firefight. A flexible system will be able to accommodate the introduction of novel components, or novel combinations of components, with any vehicular component network. Accordingly, embodiments are envisioned wherein a network address may be downloaded into at least some vehicular components.

As discussed in conjunction with FIG. 4, embodiments are envisioned in which at least one of a component has a “queue stack” 413. A queue stack is particularly useful for preventing the concealment stolen components, particularly, but not exclusively, portable components which could be easily “unplugged” during the re-powering process to avoid detection of a stolen device. Examples of such devices include GPS maps and stereo equipment. According to a preferred embodiment, before a component can function within the vehicular network, it must be assigned a network ID, and also, have its Public Key recorded in the queue stack of a designated device within the vehicle. According to this embodiment, the queue-stack 413 comprises a field of non-erasable “write only once” words. The queue stack thereby maintains a record of the Public Key of every device that is ever incorporated in the vehicle's network.

As a consequence, if a stolen components were installed in a vehicle and then “unplugged” during the re-powering process, the presence of stolen component would still be recorded in the queue stack, and the public key of the component would be transmitted to the smart grid string the handshake process.

The reader will readily appreciate that almost any component of a vehicle can be replaced. For example, an internal combustion engine could be removed and replaced with an electric motor, or an electric motor could be replaced by a newer electric motor. It can readily be appreciated, therefore, that if the queue stack used to record the component history of a vehicle were embedded in an electric motor, the replacement of an electric motor would destroy the “component history” of the vehicle as recorded in the queue stack. To minimize the likelihood of expunging the component history of the vehicle, the component history is preferably recorded in a queue stack embedded in the chassis of the vehicle, or some other “non-replaceable” structural component of the vehicle. In an alternative embodiment, the component history of the vehicle is stored in multiple queue stacks which can be compared against each other. Assume for example, that a vehicle chassis and an electric motor both have queue stack four recording component history. These queue stack store identical data of component history. If the electric motor is replaced, the component history stored in the chassis queue stack can be downloaded into the new electric motor, thereby maintaining a redundant component history. But such a redundant process, the replacement of a single component, even part of a vehicle's chassis, cannot destroy the component history of the vehicle, and therefore cannot serve to conceal stolen components.

FIG. 9A depicts an embodiment in which a user interface device 901 individually programs a network ID 419 into vehicular component 400. In this embodiment, the network ID is selected by the operator.

FIG. 9B depicts a Vehicular Component Network capable of self initialization by assigning an ascending sequence of Component IDs to the constituent Vehicular Components 155₁-155₈. The specific number of components depicted in FIG. 9B is offered as an example for purposes of illustrative clarity, and is not intended to limit, the appended claims, which can be applied to networks incorporating any number of Vehicular Components. The reader will also appreciate that many alternative self-initializing architectures are envisioned, and the embodiment depicted in FIG. 9B is offered as an example of one form of self initializing architecture.

In programming network addresses, the User Interface Device 151 transmits separate signals on the Valid line, the Cmd line and data bus “N”. The data transmitted on the data bus “N” includes the Network Address to be assigned to the first Vehicular Component 155₁. An “auto-config” command received by the Vehicular Component 155₁ one the Cmd line initializes storage of the incoming Network Address in the Address Register 183 of the Vehicular Component 155₁ receiving the command. The command is executed upon the leading edge of a clock pulse, a Valid signal, or combination thereof.

Upon receiving an “Auto-Config” command, the initialization circuit 181 of the Vehicular Component 155₁ receiving a signal stores the value received on the data bus “N” in its local address Network Address Register, increments this data value by a predetermined number (preferably by one) and retransmit the incremented value to the next Vehicular Component 155₂. In addition to transmitting the incremented value, Vehicular Component 155₁ transmits to Vehicular Component 155₂, the Auto-Config command on the Cmd line, a Valid signal pulse on the Valid line, and a clock pulse on the clock line. The process continues until all Network Components 155₁-155_{N} have been assigned network addresses. In one embodiment, the first component 155₁ in the network is assigned network address ‘1’, although other addresses are envisioned for the first component.

Thus, Vehicular Component 155₂ records device ID ‘2’ in its device ID register and transmits Component ID ‘3’ to the downstream Vehicular Component 155₃ along with a command and valid signal. In an alternative embodiment, the upstream Vehicular Component may transmit its own device ID (i.e., Vehicular Component 155₁ transmits device ID ‘1’) and the initialization circuit 181 within the downstream Vehicular Component may increment the received device ID to generate the device ID stored within its device ID register and transmitted to the subsequent downstream device.

As each Vehicular Component in the chain records a device ID and transmits an incremented device ID to its downstream neighbor, an ascending sequences of device IDs is assigned, until the final Vehicular Component in the chain records device ID ‘N’. In the particular embodiment shown, the Vehicular Network includes eight Vehicular Components, so that device ID ‘8’ is recorded by the initialization circuit of the final Vehicular Component 155₈. The initialization circuit of the final Vehicular Component 155₈ retransmits the valid signal, the “next” incremented device ID (which in the case of FIG. 9B is a ‘9’) to the User Interface Device 151, thereby concluding the self-initialization of the Vehicular Network and informing the User Interface Device 151 of the number of Vehicular Components in the Vehicular Network.

According to the architecture depicted in FIG. 9B, a “Valid” pulse is transmitted from one component to another along the “valid” signal line to indicate that command data on the Command Bus “Cmd” and data on the Data Bus “N” are valid transmissions intended for incorporation by the receiving component.

Table 2 illustrates some of the commands and data that can be transmitted in network operation

TABLE 2
Command Line

Program Network Address
Request for Public Key
Write Public Key
Read Challenge Value and generate response
Response Value
Adjust Mode of Vehicular Component
Read Response Value
Data Request
Data Response

The “Program Network Address” command has been discussed above.

The “Request Public Key” command would be issued, inter alia, by the Smart Grid 131, and may be directed to a specific network component, or may be a “broadcast” command serially directed to all network components.

The “Write Public Key” command may variously be initialized by a vehicular component, or retransmitted from component to component as the command and data transit through the network. The data transmitted on the data line in conjunction with this command may include, but is not limited to, the public key of a component and the network address of a component. Multiple public keys may be transmitted in a single digital packet, or sequentially transmitted.

A “Read Challenge Value” command is generated by the Smart Grid 131 and is accompanied on the data bus “N” by a transmission of a Challenge Value or Encrypted Challenge Value, and a network address or public key identifying the vehicular component to which the challenge is directed. The command initializes the encryption or decryption of the challenge value by vehicular component, thereby forming a Response Value. As discussed below, the Response Value is transmitted to the Smart Grid over the network for confirmation of the authenticity and status of the vehicular component.

A “Response Value” command is generated by a vehicular component after the encryption or decryption process has generated the Response Value. Data transmitted in conjunction with this command includes, but is not limited to, the response value, and the network address or public key of the vehicular component generating the response.

The command to “Adjust Mode of Vehicular Component” may be generated by the Smart Grid 131, or the owner of the vehicle. Data transmitted in conjunction with this command may include, but is not limited to, a network address or public key of a component in the vehicular network, and the mode (or modes) in which the vehicle is to operate.

A Data Request command instructs a vehicular component to provide data to the Smart Grid 131, or User Interface 151. Data transmitted in conjunction with this command may include, but is not limited to, a network address or public key of a component in the vehicular network, and the nature of the data requested.

A Data Transmission command is generated by a vehicular component in response to a request, or in response to an internal fault. Data transmitted in conjunction with this command may include, but is not limited to, a network address or public key of a Vehicular Component, and specific data relating to component performance or component history.

To limit the access of hackers to the database, the storage of new public and private keys within the database is preferably done in a multistep process. According to the preferred embodiment, data identification and storage of all new network devices is originally a temporary stores process. At the end of a predetermined period of time (e.g., an hour, or a day) a secure process transfers any new data to the “permanent database. As discussed herein, any changes to the that includes error-checking, stringent virus checks, and preferably transistor level software impervious to viruses.

System Access and Security

FIG. 10 describes a security process for preventing “hacking” of the system. It can be readily appreciated that system security is essential to preventing or interrupting automobile theft. According to a preferred embodiment, a national licensing process—analogous to the certification of airline mechanics, is utilized. Strict national standards are instituted to prevent insider fraud, and strict laws are enacted to punish acts, or attempts at system fraud by certified mechanics.

In step 1001, individuals are screened and examined for security clearance in a national automobile database.

In step 1003, those persons passing the screening and examination procedures a granted a federal license or registration.

In step 1005, licensed agents are issued a password and a fob. Fobs have become increasingly popular in cyber security applications. In one embodiment, has a unique public key, a unique private key, a clock, and an encryption algorithm. A digital value appears on a “screen” such as a digital wristwatch. The value appearing on the screen is generated by the encryption algorithm within the fob according to the private key within the fob. The number may be generated from any number of sources, but preferably includes a value derived from a clock internal to the fob. At regular intervals (for example, 30 second intervals), the value displayed on the screen is updated. When a user with a security clearance attempt to access a secure database, the user must provide his personal password, and the value displayed on the fob at that given moment. The reader will appreciate that these security measures are offered as examples, and are not intended to limit the scope of the appended claims. It will further be appreciated that multiple security levels can be established, with increased safeguards at each level. Such safeguards are necessary in view of the fact that the system described herein is capable of eliminating virtually all automobile theft if implemented properly.

In step 1007, a central database 309-A updates “local” or “mirror” data bases serving local Power Providers 107. The number of local databases operational across the country is preferably sufficient to prevent “server overload” at peak operational times of the day. According to a preferred embodiment, the central database used to update local databases is recorded on a “read only” medium, thereby safeguarding the national database against “hackers”

In step 1009, a mechanic installs a new component in a vehicle, and integrates the new component into the vehicular network. As described in conjunction with FIG. 9, this may include reinitializing the vehicular network, thereby reassigning new network addresses to all of the vehicular components within the automobile that has been repaired.

In step 1011, the mechanic couples a digital port of the vehicle to a digital port of the Smart Grid, and indicates via software interface that a component has been added or replaced. In addition to the automated collection of information between the vehicle and the Smart Grid, specific questions may be directed to the mechanic or user, including, but not limited to, the condition of any component remove from the vehicle, confirmation of the public key of component(s) removed from the vehicle, information about parties purchasing old components from the vehicle, information about parties who provided the new components installed in the vehicle, etc. Additionally, specific instructions may be issued to the mechanic regarding the proper disposal/recycling components removed from the vehicle, and the notification of penalties assessed for failure to comply with disposal and recycling procedures.

According to an embodiment, the information recorded by the Smart Grid in the preceding step is collected at a “low level” data processing center, and subsequently transmitted to a central authority maintaining the database of the Smart Grid. By this “layered” architecture, the central database is insulated from hacking. According to a preferred embodiment, the central database cannot be accessed from the Internet, but must be accessed “on-site,” which may include a secure intranet or LAN.

In step 1013, a responsible party, such as the mechanic, delivers a used component to a proper recycling center.

In step 1015, an agent at the recycling center couples the used component to a digital port that accesses the smart grid, which confirms that the component has been properly recycled.

Inventory Control and Management

The data base systems described herein will advantageously collect data regarding the performance and/or failure of components and component systems, thereby enabling manufacturers of automobiles and trucks to identify and reengineer unreliable components and systems. Additionally, the methods and apparatuses described herein are useful not only for antitheft applications, but are also useful in confirming or preventing fraud (the resale of a used or damaged component as “new”), and inventory control and management. For example, military applications, operational parts are swapped out of non-operational vehicles to maintaining combat readiness of other vehicles.

In step 1101, a fleet of military vehicles is manufactured or retrofitted with digitally identified components arranged in a digital network within the vehicle. The database is developed to track these vehicles and their respective components.

In step 1103, certain vehicles from among the fleet are disabled due to usage, wear and tear, or battlefield engagement.

In step 1105, the military vehicle database is updated to identify specific vehicular components that have become nonfunctional. According to a preferred embodiment, the database includes a data field corresponding to each component, wherein the combat readiness of an individual components can be identified. A single-bit data field is sufficient to identify a piece as functional or disabled. A multi-bit data field can facilitate a greater list of diagnostic code identifying the condition of a component.

In step 1107, maintenance personnel repairing a military vehicle identify a component that needs to be replaced to restore the vehicle to battlefield readiness.

In step 1109, the maintenance personnel access the database searching for disabled vehicles which have a functional version of the desired component. The database will advantageously have filters which allow vehicles to be identified based on a number of criteria. For example, an algorithm will preferably rate the overall combat readiness of a vehicle. Assuming a combat readiness a scale of 1 to 100, if a vehicle being repaired has a battlefield readiness rating of 75, it would be counterproductive to field strip a component from a disabled vehicle which had a battlefield readiness rating of 95. By incorporating the use of “filters” in the search and identification process, maintenance personnel could search for an operational version of the desired component among vehicles with a battlefield readiness rating of 10 or less. If the search failed to identify a functional version of the desired component, the maintenance personnel could search for the desired component among vehicles with a battlefield readiness rating of 20 or less. This incremental search process, or equivalent procedures, ensure that maintenance steps are not counterproductive, and are not degrading overall combat readiness. Maintenance technicians would not have to guess or estimate which vehicles should be field stripped of components and which should be rebuilt. These decisions can be mathematically quantified by the data base. Additionally, the database provides a robust and accurate pool of information as to where specific components may be available, even in unrelated vehicles.

In step 1111, the functional component is field stripped from one vehicle, and installed into another vehicle, thereby maintaining greater combat readiness among the fleet of military vehicles.

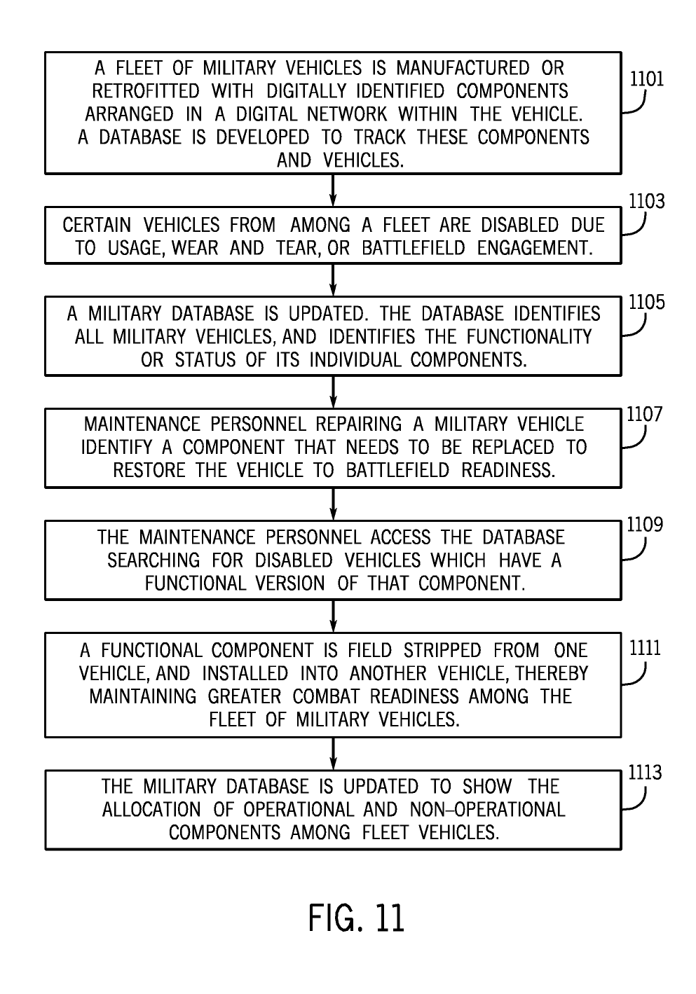

The reader will appreciate that the process described in FIG. 11 has nonmilitary application, such as for a fleet of rental cars. Illustration in terms of military vehicles is therefore offered as an illustration, and not intended to limit the application of the process described in FIG. 11. For example, the foregoing process can be utilized by “junkyards” to more efficiently track component among scraped vehicles and commercial recycling as well.

Recall Notices and Product Updates

FIG. 12-A depicts an example of a message notifying a consumer/user about hardware recalls and updates—including both optional and required updates. The messages are preferably delivered in a variety of formats. For example, a touch screen input at the power provider may display the message during the repowering process. In an embodiment, acknowledgment by the user is required before the repowering process may commence.

FIG. 12-B depicts an example of a message notifying a consumer about software recalls and updates—including both optional and required updates.

Off-Grid Recharging

Although traditional gasoline cars typically have to refuel at a public power station, electric cars may be recharged in the garage of a user. It can be readily appreciated that such charging could be used to circumvent anti-theft measures incorporated in the foregoing description, such as depicted in FIGS. 1, 3A and 3B. According to an embodiment, home charging units are in communication with the smart grid, and will therefore report stoline vehicles in a manner discussed above. However, it is foreseeable that an individual consumer loose web access for a period. If vehicle recharging at home were prevented during such times, a consumer could be deprived of use of their vehicle during an emergency situation. However, if wholesale off-grid charging were permitted, it could easily circumvent the foregoing anti-theft measures. Therefore, off-grid charging is preferably permitted, but limited by one or more factors. In an embodiment, vehicular recharging is measured in 1% increments. A vehicle is permitted to recharge a predetermined number of times (e.g. five complete rechargings) without re-accessing the grid. Suitable warnings alert a driver as to the need to re-connect to the smart-grid, and the number of rechargings that remain before the vehicle is disabled. In an alternative embodiment, an internal timer within the vehicular network limits off-grid charging for a predetermined period of time. If the vehicle does not access the grid within that period, the vehicle is disabled.

Cellular Grid Connection

In an embodiment, the requisite reconnection with the grid is executed over a digital RF network such as a cellular network. Although the “smart-grid cellular network” could be allotted a separate operational frequency through various national communication authorities such as the FCC in the United Stated, according to an embodiment, a unique digital prefix is allotted to the smart grid cellular network, thereby permitting it to operate on the same frequency as current cellular technology, and even using existing cellular transmission towers. In an embodiment, if a vehicle has not communicated with the smart-grid in a predetermined amount of time (e.g. four days), the smart-grid initiates a digital hand shake through the cellular network, and inventories the vehicle's components at that time. In this way, the cellular communication consumes minimum bandwidth. Most vehicles will have communicated with the smart grid during the repowering process, and even if they do not, a digital challenge and response can be accomplished in a fraction of a second. Apart from being performed over a cellular network, the hand shake is otherwise identical to those described in conjunction with the foregoing figures.

In an embodiment, vehicles that have not “checked in” with the smart-grid in a predetermined period of time are given a priority. If a vehicle 101 has just passed the minimum period (e.g. four days), it is given the lowest priority. The smart-grid attempts to re-contact the vehicle at regular intervals. If the “off-grid” status of the vehicle exceeds a second period of time (e.g., five days), the status is upgraded, and the smart-grid initiates more frequent attempts to contact the vehicle. Finally, if the off-grid status of a vehicle exceeds a certain threshold, a hard response is executed. The hard response may include, but is not limited to, disabling the vehicle, summoning law enforcement authorities, etc. Hard responses will preferably be predicated on a number of factors other than the length of time a vehicle has been “off grid.” For example, if a vehicle has a history of being in rural areas with poor cellular connection, the threshold for initiating a “hard response” may be increased.

By incorporating an embodiments of a cellular smart-grid hand shake, off-grid recharging at home may be performed without requiring an automobile owner to purchase home internet access, and can further impede vehicle thieves from avoiding detection

Non-Automotive Portable Electronic Devices

The methods and apparatuses described herein can not only provide anti-theft protection to automotive components, they may be utilized to provide anti-theft protection to non-automotive components as well. FIG. 13-A depicts the dashboard 1300 of a vehicle. A plurality of digital ports 1301 are disposed on the vehicle dashboard, depicted, by way of example, as USB ports which provide digital access to the vehicular network through an auxiliary component interface 1303 depicted in phantom. The auxiliary component interface, may correspond, for example, to network element 1557 of FIG. 9-B. Table 1 depicted an embodiment in which network addresses are predetermined, showing the second from the bottom as an “Auxiliary Component Interface” having a predetermined network address of 00010011. As discussed in conjunction with FIG. 9-B, rather than assigning predetermined network addresses to certain types of components, the network address of each component may be generated in a self programming operation. The auxiliary component interface 1303 thereby functions to reserve a network address for portable components that may be added to and removed from the network.

Those skilled in the art will appreciate that alternative network architectures may be employed, including, but not limited to the serial (chain) network of FIG. 9-B, a trunk line/drop line architecture, or a “star” or hub” architecture. Similarly, network protocols may include, but are not limited to, token-polling, token-passing, and collision protocols. Specific architecture and protocol embodiments described herein are therefore offered for illustrative purposes, and are not intended to limit alternative networks and protocols used in conjunction with the embodiments described herein.

A touch screen 1307 on the dashboard operates in conjunction with the auxiliary component interface 1303, allowing a user to configure and/or activate a portable electronic device that attaches to the automotive network FIG. 9-B through a digital port 1301.

Some portable devices such as a GPS map are primarily used in conjunction with an automobile. However, other portable electronic devices, such as a notebook computer or a cellular telephone, have significant functional use outside of an automobile. Such devices are therefore referred to herein as “non-automotive electronic devices.”

FIG. 14 depicts a non-automotive portable electronic device 1400 being coupled to an auxiliary port 1301 of the vehicular network by a signal path such as a USB cable. The portable electronic device may include, but is not limited to, a cellular telephone, a camera, a notebook computer, a portable memory device such as a flash drive, a music playback device such as an iPod, a gaming console, the digital planner or calendar, a stereo, a radio, or any other mobile electronic device known as the present time, or which may be developed in the future. Moreover, those of ordinary skill in the art will appreciate that most mobile computing devices are “multifunction”. For example, a notebook computer often has a camera built in, and may include wireless capability enabling it to attach to a cellular network, with VoIP software, thereby combining functionality traditionally associated with a notebook computer with video camera and cellular telephone functionality. In the following examples, therefore, reference to a “single function” device, such as a cellular telephone, is offered for simplicity of illustration, and is not intended to limit the scope of the appended claims, which fully comprehend other portable electronic devices.

The non-automotive electronic device 1400 of FIG. 14 advantageously includes certain architectural distinctions from the automotive components depicted in FIGS. 4 & 5. The portable electronic device 1400 includes an antitheft module 1401 that includes a unique public key 1403, an encryption/decryption module 1405, and a private key 1407 used by the encryption/decryption module in the encryption or decryption of data. An operational timer 1409 includes a preset value 1411, an accumulated value 1413, a “timer timing bit” (abbreviated as the T-T bit) 1415 (which activates the timer or indicates that the timer is active), and a “timed-out bit” 1417 (T-O bit) indicating that the accumulated value of the timer has reached the preset value. The timed-out bit transitions from a zero to a one when the accumulated value reaches a preset value. In an embodiment, the anti-theft feature is activated by setting the T-T bit to a 1. Once the anti-theft feature is activated, the device owner must reset the accumulated value 1413 to zero on a regular basis to maintain device functionality. The portable electronic device will disable itself the accumulated time 1413 reaches the preset value 1411. In an embodiment, the disable function is governed by the timed-out bit 1417. The operational timer thereby functions to disable the device if its ownership is not revalidated within a predetermined period of time. For example, if the preset time were set for thirty days, the device would be disabled at the end of thirty days if the accumulated value were not reset to zero, and the timed-out bit also reset to zero.

In an embodiment describe herein, the resetting of the accumulated value is dependent on the device being coupled to, or otherwise accessing the smart grid through that vehicle. However, alternative embodiments are envisioned, wherein the antitheft module can be reset by coupling with any predetermined network or device. If the reset operation is conducted when coupled to a secure network, such as the smart grid, the reset operation is preferably dependent upon a challenge and response utilizing a private key. If the reset operation is performed through coupling to another component, or a non-secure network, the reset operation is preferably performed with a public key only.

The portable electronic device 1400 also includes a latency timer 1417 which includes a timer preset field 1419, a timer accumulated field 1421, and a timer-timing bit 1423 and a timed-out bit 1425. As will be further appreciated by the processes described below, the latency timer functions to prevent hackers from circumventing the antitheft security features described herein by bombarding the device with artificially generated “hand shakes”.

A warning field 1431 allows a user to configure the device to initiate a warning, alerting the user that he or she must revalidated ownership within a certain number of days, or the device will be disabled. Assume, for example, a preset operational time of thirty days, and that the value entered in the warning field represents five days. If ownership of the device has not been revalidated for twenty-five days, a warning will advise the user that a specific device will be disabled if not revalidated within five days. The warning can be in any form, including, but not limited to, an audio warning played of the vehicle's speakers, or a text or visual warning displayed on a monitor of the dashboard of the vehicle, or a text message to the user's cell phone.

Configuration of the Anti-Theft Properties of a Portable Electronic Device

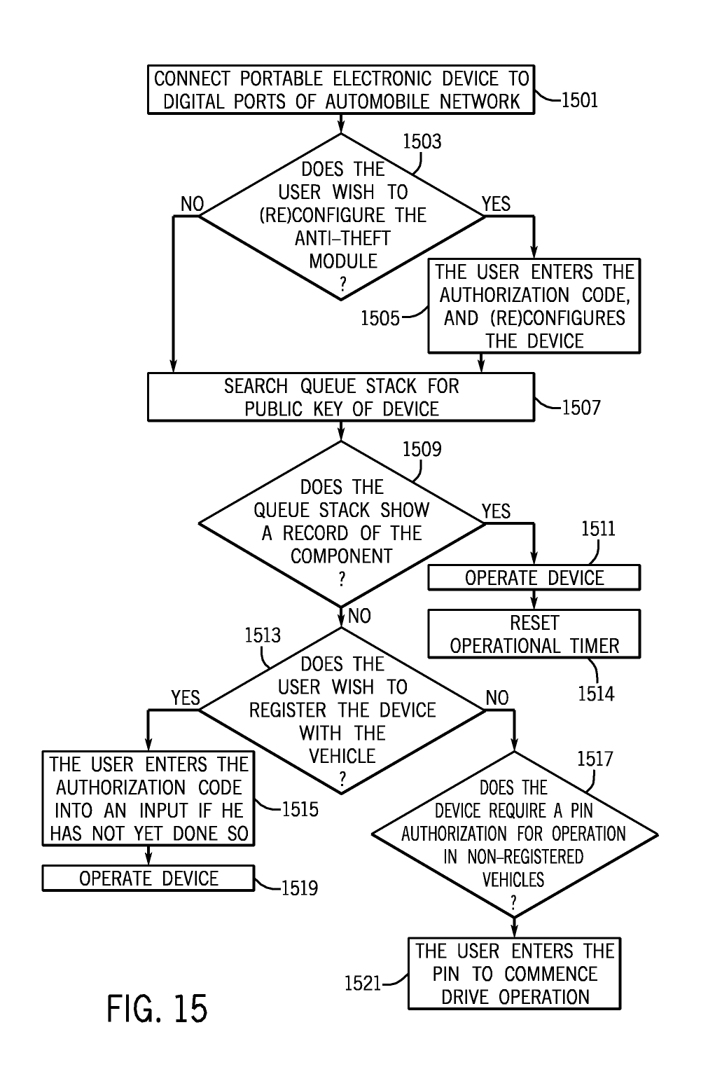

FIG. 15 describes a sequence of steps in which the antitheft feature of a portable electronic device is configured by the user.

In step 1501, a user couples a portable electronic device 1400 to one of the digital ports 1301 that grant access to the vehicular network of FIG. 9-B.

In step 1503, if the user selects to configure or reconfigure the anti-theft module, then in step 1505, the user enters the authorization code required to access the device. The user then reconfigures the device. The authorization code is preferably a unique factory assigned code similar to the authorization code or key that comes with a software applications to limit the number of computers on which the software application may be functionally installed. To enhance readability of the process described in FIG. 15, specific details about the configuration process of step 1505 are reserved for discussion at the completion of the discussion of FIG. 15.

In step 1507, the network searches the queue stack of the vehicle for a public key matching the portable electronic device 1400. In vehicles in which some of the components have “redundant” queue stacks, it is understood that one component is designated as the “primary” component. The queue stack in the “primary” component is the vehicular queue stack responsible for providing the list of pubic keys to be transmitted to the smart grid.

In step 1509, if the public key of the device has been recorded in the queue stack, then in step 1511, the device is rendered operational. In an embodiment, the accumulated value of the operational timer is reset if the public key has been recorded in the queue stack.

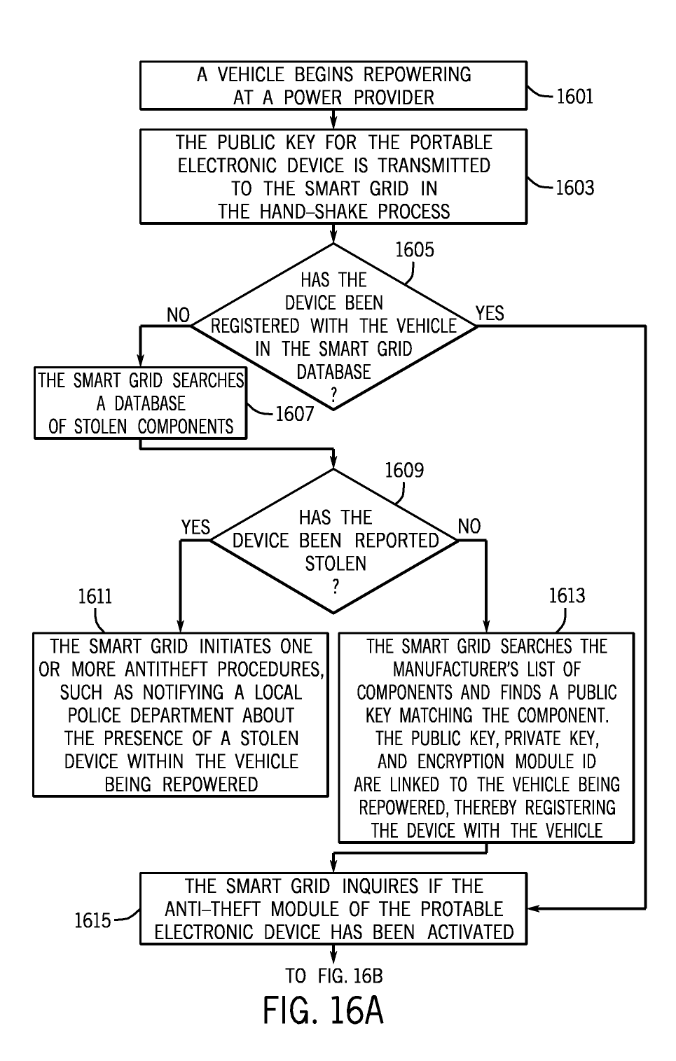

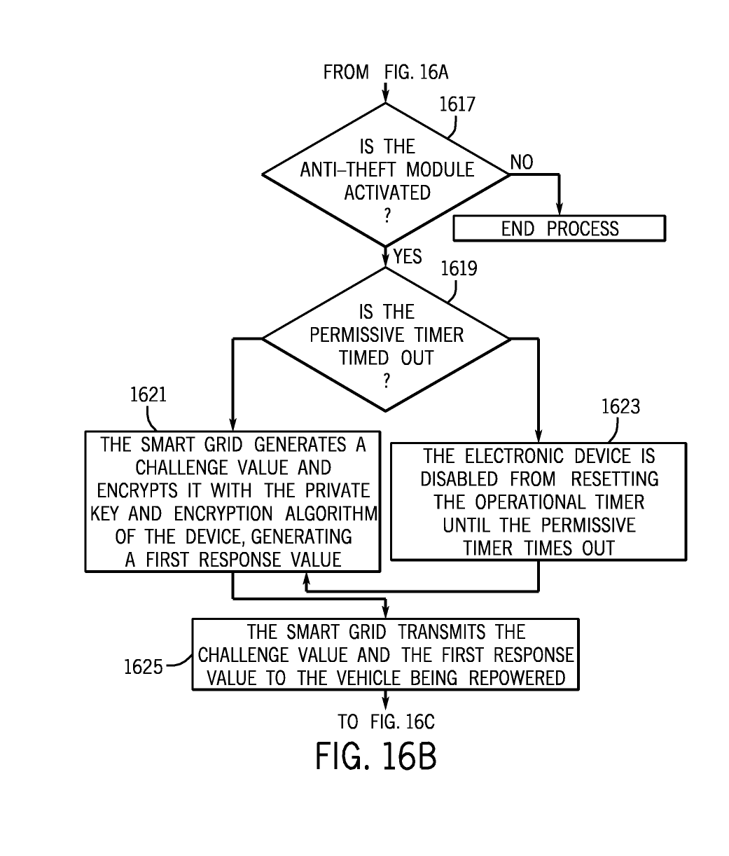

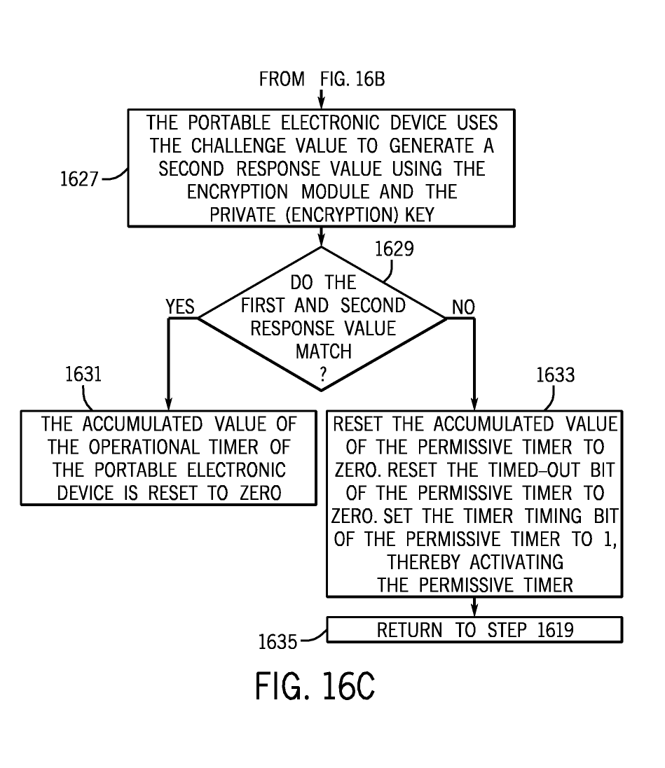

Step 1514 depicts an embodiment wherein, if the portable electronic device is recognized by a vehicular network, the operational timer is reset. FIG. 16 depicts an alternative embodiment wherein the operational timer of the device can only be reset while the vehicle is in communication with the smart grid, such as during a repowering process.

If, in step 1509, the device is not found in the queue stack of the vehicle, then in step 1513, the user is asked if they want to register the device with the vehicle.

If, in step 1513, the user does not elect to register the device with the vehicle, then in step 1517, the network determines if the device requires a PIN to operate in a guest vehicle. If, in step 1517, the device does not require a PIN authorization to operate in non-registered vehicles, the device is rendered operational.

If, in step 1517, a PIN is required to operate the device in a guest vehicle, then in step 1521, the user enters the guest PIN to render the device operational. The reader will appreciate that the use of a guest PIN is a second level of anti theft protection. The first level of anti-theft protection is the auto-disable feature wherein, if the device is not “paired” with the proper respondent within a predetermined time period, the device is rendered inoperative. The second level of security, requiring a PIN to operate the device, is described in FIG. 15 as specifically relating to an automotive portable electronic devices such as a GPS. The reader will appreciate that equivalent embodiments can be incorporated with the non-automotive electronic devices. For example, a cellular telephone might require the user to enter a password to the telephone keypad. Device configuration would advantageously allow the user to determine the time period for which the device is to remain operational following entrance of the password into the keypad. Because the device will eventually be disabled if ownership is not validated, theft deterrence is not dependent exclusively upon the complexity of the password. Accordingly, “user-friendly” passwords of four or five characters will be considered sufficient for most users.

Returning to step 1513, if the user elects to register the device with a vehicle, the user would be able to reset the auto-disable feature of the portable electronic device simply by coupling the device to the network of that vehicle at some future time (FIG. 15, step 1514), or, according to the embodiment of FIG. 16, by re-powering the vehicle while the device is coupled to the vehicle's network.

In step 1515, if the user has not already entered the authorization code, this is required before the device is registered with the vehicle.

In step 1519, the public key of the portable electronic device is written into the queue stack of the vehicle, thereby registering the device with that vehicle.

Configuration of the Anti-Theft Module

As discussed in conjunction with FIG. 14, a portable electronic device has an operational timer and a latency timer. The anti-theft module can be activated, for example, by changing the state of the “timer timing bit” from a zero to a one. A user interface advantageously permits an owner of a device to turn the anti-theft module on or off at will. The operational timer has a preset field. This may be a fixed time set by a manufacturer, or may be configurable by the consumer. The preset value determines the length of time the device will operate before disabling itself. If a user were to set the operational timer preset value at thirty days, the device would operate for thirty days before disabling the device functionality. When the accumulated value of the timer equaled the preset value, the “timed out” bit would transition from a zero to a one, disabling the device. To maintain operational status, a user must reset the accumulated time to zero within thirty days of the last time it was reset.

In an embodiment, the accumulated value is reset when the portable electronic device is coupled to a vehicle's network, and the vehicle is in communication with the smart grid, such as during the repowering (refueling/recharging) process. By requiring revalidation of ownership at regular intervals, the value of the electronic device to a potential thief is greatly reduced, thereby reducing the likelihood of theft.

The configuration process also includes a “warning field.” The user enters a time at which a warning will appear. For example, a user configures a cellular telephone to disable after 30 days if not revalidated, and configures the “warning time” at five days. If the user goes more than 25 days without revalidating the ownership of the cellular telephone, whenever the user starts an automobile with which the device is paired, the vehicular network will issue a warning. For example, a monitor could display the warning, “Carolyn's cell phone has five operational days remaining.”

It is foreseeable that a user may travel out of town with a portable electronic device, thereby lacking access to a paired component (e.g. a car) necessary to re-set the accumulated value of the operational timer. According to an embodiment, therefore, a user may disable the anti-theft module.

In an embodiment, the configuration process will be able to select from alternative modes for resetting the accumulated value of the operational timer. A low level security feature would simply require a password entered through an input of the device. A higher level of security would inure from requiring communication with a trusted source such as the smart grid.

In embodiments in which the accumulated value 1413 of the operational timer 1409 is reset during the repowering of a vehicle, the portable electronic device 1400 is preferably configured such that the anti-theft features cannot be activated until the portable electronic device is “linked” or “registered” with at least one vehicle. The activation is therefore preferably the final stage step of the initial registration process.

Once the anti-theft features of a portable electronic device 1400 are activated, the device will be rendered inoperative within a predetermined time frame if it is stolen, significantly decreasing value to a potential thief. Therefore, an appropriate anti-theft logo, trademark or certification is conspicuously displayed on such electronic devices to curtail the motivation of potential thieves.

Activating, de-activating, setting or adjusting the preset value, setting or adjusting the time for the warning to initiate, and other configuration data can be entered through the touch screen 1307 of the vehicle.

The Registration Process

As discussed in FIG. 15, registration may be accomplished simply by coupling the device 1400 with a second device, such as the vehicle 101 through an appropriate interface 1301, 1303. FIG. 16 describes an alternative registration/revalidation process of a portable device 1400 that requires not only that the device 1400 is coupled with another device such as the vehicle 101, but also, that the vehicle is coupled with the data base of the smart grid.

In the embodiment of FIG. 16, activation of the anti-theft module may be initiated at any time. However, it is preferably limited to a point in time after the public key is stored in the queue stack of at least one vehicle, or until such a time as the device is recorded in the data base of the smart grid in association with at least one vehicle.

In step 1601, the vehicle 101 (see FIG. 1) begins the repowering process at a power provider 107. The process of FIG. 16 assumes that the registration process described in FIG. 15 has been completed between the portable electronic device 1400 in the vehicle 101.

In step 1603, the public key 1403 of the portable electronic component 1400 is uploaded to the smart grid during the hand-shake process.

In step 1605, the smart grid 131 determines if the public key 1403 of the portable electronic component 1400 is already registered with the vehicle being refueled or recharged. Referring briefly to the database of FIG. 6, registration with a vehicle can be conceptually understood as being in the same “row” as the automobile being repowered.

If the public key 1403 has not been associated with the vehicle being refueled, in step 1607, the smart grid searches a database of stolen components.

In step 1609, if a device 1400 has been reported stolen, then in step 1611, the smart grid initiates one or more antitheft procedures, such as notifying a local Police Department about the presence of a stolen device within the vehicle being repowered.

In step 1609, if the device 1400 has not been reported stolen, then in step 1613, the smart grid searches the “manufacturer's list” within the data base to ascertain the private key and encryption module ID used in conjunction with the device.

The database (shown, in part, in FIG. 6) advantageously includes a “manufacturer's listing” (not shown) of all devices referenced by the database. The manufacture's listing cross-references the public key of every component registered with the smart grid with the private key 1407 and the encryption algorithm associated with that component, as well as other possible data such as the nature of the component (a GPS map, an electric motor, etc.) and a specific component data (e.g., if the component is an electric motor, a manufacturer's code may identify the manufacturer and the year in which the motor was manufactured, as well as the part number. From that data, other databases can be accessed which can provide a virtually unlimited amount of data about the component.) The manufacturer's listing also includes the unique authorization code or license that came with the purchase of the product. This code is required during to register the electronic device with a vehicle, the activation, configuration, or re-configuration of the anti-theft module. The authorization code is analogous to the unique code that typically comes with the purchase of software to limit the number of users.

To optimize operation of the data base and the smart grid, the public key, private key, and encryption algorithm ID are preferably linked to the vehicle in the data base. This can be achieved writing this data in predetermined fields. Alternatively, pointers or indirect addressing may be used. Data base architecture is well known, and will therefore not be discussed herein.

This process allows a portable electronic device to be registered with any number of cars, providing greater flexibility to the consumer. A family possessing two cars is able to reset the antitheft module 1401 of a portable electronic device 1400 from either vehicle.

In step 1617, the smart grid examines the Timer Timing bit 1415 and timed-out bit 1417 to determine if the anti-theft module 1401 has been activated and/or disabled. If the Timer Timing bit is or timed-out bit are “on,” the anti-theft module has been activated, and the smart grid commences with the reset process. The device is reset by overwriting the accumulated value 1413 of the operational timer to zero, and overwriting the timed-out bit 1417 to a zero as well. To prevent easy thwarting of the security system by hackers, two different safety measures are described in conjunction with steps 1619-1637.

In FIG. 7, a public-key/private-key challenge and response process was described by which the smart grid confirms the status of an automotive component. Although embodiments are envisioned by which this process is repeated for non-automotive devices, the reader will appreciate that, in order to securely reset the accumulated value of the operational timer of a non-automotive component, it is not critical that the smart grid recognizes a device. However, it is imperative that the portable electronic device 1400 reliably confirm that it is communicating with the smart grid, and not an artificial handshake generated by a hacker

Resetting the Operational Timer

Steps 1619-1637 describe the steps for resetting the operational timer of an anti-theft module. Although step 1619 occurs at the beginning of this process, the explanation of step 1619 is best understood after a description of steps 1621-1637.

In step 1621, the smart grid generates a challenge value. Recalling that the database 600 records the encryption algorithm 1405 and private key 1407 of the portable electronic device 1400, the smart grid also encrypts the challenge value according to the private key and encryption algorithm of the device, generating a first encrypted response.

In step 1625, the smart grid transmits both the challenge value and the response value to the portable electronic component.

In step 1627, the portable electronic device encrypts the challenge value, generating a second encrypted response.

In step 1629, the portable electronic device compares the encrypted response that it generated to the encrypted response it received from the smart grid.

In step 1631, if the encrypted responses match, an authentic connection with the smart grid is confirmed, and the portable electronic device 1400 resets the accumulated value 1413 of the operational timer 1409 to zero, and overwrites the timed-out bit with a zero.

By requiring a successful encrypted response from the smart grid, the ability of a hacker to reset the accumulated value through an artificial hand shake is substantially reduced.

The reader will appreciate, however, that a simple program could be developed by a hacker, wherein a simple laptop computer could engage a stolen component with billions of artificial handshakes every minute. Let us assume, for sake of illustration, that the encrypted response value used to authenticate a handshake with the smart grid is a 32-bit value. This means that there are 4,294,705,165 possible encrypted responses. By generating billions of artificial handshakes every minute, such a program could, within a matter of minutes, generate a valid challenge and response pair by sheer random probability, thereby allowing the hacker to disable the antitheft module of a portable electronic device, and resell or reuse the stolen device.

Referring briefly to FIG. 14, the antitheft module 1401 of the device 1400 includes a “latency timer” 1417 with a timer preset field 1419, a timer accumulated field 1421, a timer timing bit 1423 and timed-out bit 1425. Returning to FIG. 16, in step 1629, if the first encrypted response (supposedly received from the smart grid) does not match the second encrypted response (generated by the device), there exists a possibility that a hacker is attempting to disable the anti-theft module.

To prevent a hacker from generating billions of artificial hand shakes, in step 1629, a failed handshake resets the accumulated value 1421 of the latency timer 1417 to zero. The timed-out bit 1425 is also reset to zero, and the timer-timing bit 1423 to a “one.”

Returning to step 1635, after a failed handshake, and the resetting of the latency timer 1417, the process returns to step 1619, inquiring as to the status of the latency timer. The device 1400 will not recognize any further handshake during the latency period of the latency timer. Assume, for example, a latency period of fifteen seconds is written in the preset field of the latency timer. In the event a hacker generated an artificial handshake in an attempt to disable the anti-theft module, the failed handshake resets the accumulated time 1421 to zero, and initializes the timer-timing bit. The anti-theft module 1401 is programmed so that it will not recognize as valid any challenge and response until the accumulated value 1421 again reaches the preset value 1419, at which time the timed-out bit 1425 transitions to a “1”. By using a fifteen second latency period, an artificial hand shake program employed by black market hackers could only present four challenge and responses each minute. At this rate, for a thirty-two bit field, it would take approximately 2000 years for an artificial hand shake algorithm to generate a correct challenge and response by random probability. The incorporation of a latency timer 1417 in the antitheft module, therefore degrades the ability of hackers to circumvent the antitheft features by bombarding the portable electronic device 1400 with billions of artificial handshakes.

Referring therefore to step 1619, before ownership of the portable electronic device 1400 can be revalidated, the latency timer must be timed out. If not, according to step 1623, the timer in the anti-theft module may not be re-set.

The reader will appreciate that, if a latency period is too short, it allows a hacker more attempts to “crack” the anti-theft module 1401. On the other hand, noise, or a poor electrical connection with the smart grid could result in an “inaccurate” response by the smart grid, thereby initializing the latency period imposed between handshakes. If the latency period were an hour, a simple miscommunication with the smart grid due to electrical noise would require the user to wait at the refueling station for an hour before the portable electronic device 1400 would accept another challenge and response handshake. For this reason, the preset value of a latency timer will advantageously be within the range of approximately one second to one minute. However, the appended claims fully comprehend shorter latency periods ranging from one billionth of a second to one second, and longer latency periods ranging from one minute to ten years.

Additionally, the appended claims envision the use of extremely long public keys and/or response values (such as 128 bits or longer), thereby reducing the ability of a hacker to generate a successful artificial hand shake.

Alternative Authentication Processes

Although the antitheft configuration of nonautomotive electronic components is described throughout this disclosure as working in conjunction with a vehicular network, the appended claims fully comprehend alternative embodiments in which the antitheft processes and apparatuses described herein may be implemented in cooperation with alternative devices or networks.

In an embodiment, the process of revalidating the ownership of a portable electronic device 1400 is performed by “pairing” the digital device 1400 with a second digital devices such a personal computer, gaming console, cell phone, GPS, or some other mobile computing device. Alternatively, ownership of the portable electronic device 1400 may be revalidated by “pairing” the device 1400 with a “non-mobile” electronic device such as a flat screen TV. The revalidation may be mutual, one “one-way.” Referring to the device being revalidated as the “object device” and the object performing the validation as the “master device,” the object device 1400 advantageously has a “validation stack” 1433 which may store a number of values. The first register of the validation stack 1433 stores the factory authorization code. The other registers are programmable to store the public keys of a number of other “master” digital components. Assume, for example, a cellular telephone is the object device 1400 paired with a gaming console. The pairing process requires the devices to be in digital communication we each other. Communication may be by USB cable, infra red, or any other signaling channel. The product key that came with the purchase of the cellular telephone is entered through a keypad, thereby authorizing “pairing” of the cellular telephone with a gaming console. Upon user authorization, the public key of the gaming console is transmitted to the cellular telephone, and written in the next available register of the validation stack 1433 of the cellular telephone. From that point in time, digital pairing of the cellular telephone with the gaming console will reset the auto disable feature of the cellular telephone. Anti-theft embodiments using “paired devices” preferably do not incorporate “private key” encryption/decryption schemes.

As noted above, hackers may try to circumvent such a security feature by inputting billions of random values every minute into the digital port of the cellular telephone, attempt to match, by sheer volume, one of the public keys stored in the validation stack 1433 of the cellular telephone. As discussed in conjunction with FIGS. 14 and 16, a “latency timer” may be used in conjunction with a “device pairing embodiment” to limit the number of inputs which a device will recognized in a single minute.

Within the foregoing discussion, many specific details have been included an example of how to make and use the foregoing methods and apparatuses. The details have been offered to assist the reader in understanding the embodiments described herein, and are not intended to limit the spirit and scope of the appended claims, which fully comprehend alternative apparatuses, architectures and methods for implementing goals and objectives described herein.

1. (canceled)

2. An apparatus for detecting the trafficking of stolen automobile parts, comprising:
a. a first vehicle having first and second automotive components respectively comprising first and second public digital component values;
b. a second vehicle having third and fourth automotive components respectively comprising third and fourth public digital component values;
c. a smart grid having a central database that comprises:
i. first and second public digital database values corresponding to the first and second public digital component values; and,
ii. third and fourth public digital database values corresponding to the third and fourth public digital component values.

3. The apparatus of claim 2, further comprising a means for signal communication between the smart grid and the first vehicle.

4. The apparatus of claim 2, wherein the means for signal communication includes at least one passive RF tag within the first vehicle.

5. The apparatus of claim 2, wherein the means for signal communication includes at least one active RF transceiver in the first vehicle.

6. The apparatus of claim 2, wherein the means for signal communication includes an internet connection.

7. The apparatus of claim 2, wherein the means for signal communication includes means for cellular communication.

8. The apparatus of claim 2, wherein the means for signal communication includes a fiber optical signal path.

9. The apparatus of claim 2, wherein the means for signal communication includes a conductive signal path.

10. The apparatus of claim 2, wherein the central database further comprises a first private digital database value logically related to the first public digital database value.

11. The apparatus of claim 10, wherein the first automotive component further comprises a first private digital component value corresponding to the first private digital database value.

12. The apparatus of claim 11, wherein the central database further comprises a first encryption/decryption algorithm in logical relationship with the first private digital database value.

13. The apparatus of claim 12, wherein the first component has an encryption/decryption component comprising the first encryption/decryption algorithm.

14. The apparatus of claim 2, the first vehicle further comprising a signal bus connecting the first and second automotive components.

15. The apparatus of claim 14, the first vehicle further comprising a non-erasable queue stack for recording digital values, wherein the non-erasable queue stack is coupled to the signal bus.

16. The apparatus of claim 15, further comprising a timer configured to limit the frequency that a new non-erasable value may be written into the queue stack.

17. The apparatus of claim 14, the first and second components having respective first and second address fields for storing a digital value of a network address.

18. The apparatus of claim 14, the first and second automotive components further comprising a storage field for a response value.

19. The apparatus of claim 2, the smart grid further comprising at least one mirror database, wherein the central database is a secure, restricted-access database, and wherein the at least one minor database is coupled to receive updates from the central database.

20. The apparatus of claim 2, wherein the first vehicle is an electric vehicle that recharges through an electrical outlet, the smart grid being configured to meter electricity to the first vehicle according to consumer configurable parameters.

21. The apparatus of claim 2, the smart grid further comprising at least one automated camera, and software applications designed to identify and focus on relevant theft deterrent information selected from among a group consisting of human faces and license plates.
